(19) United States
(12) Patent Application Publication
(10) Pub. No.: US 2025/0382556 A1
(43) Pub. Date: Dec. 18, 2025

(54) MODULATION OF THE BRANCHED-CHAIN METABOLITE CONTENT OF FRUITS AND VEGETABLES

(71) Applicant: BOARD OF TRUSTEES OF MICHIGAN STATE UNIVERSITY, East Lansing, MI (US)

(72) Inventors: Philip Engelgau, East Lansing, MI (US); Randolph Beaudry, East Lansing, MI (US)

(21) Appl. No.: 19/239,103

(22) Filed: Jun. 16, 2025

Related U.S. Application Data
(60) Provisional application No. 63/660,119, filed on Jun. 14, 2024.

(51) Int. Cl. C12G 3/026; A23L 19/00

(52) U.S. Cl. CPC C12G 3/026; A23L 19/00

(57) ABSTRACT

Methods for reducing branched-chain metabolites in fruits and vegetables by applying acetohydroxyacid synthase (AHAS) inhibitors are disclosed. The treated fruits and vegetables have reduced levels of branched-chain metabolites, resulting in altered flavor profiles. Also disclosed are treatment compositions containing AHAS inhibitors for altering flavor.

### CROSS REFERENCE TO RELATED APPLICATIONS

This application claims priority to provisional application U.S. Ser. No. 63/660,119, filed Jun. 14, 2024, which is incorporated herein by reference in its entirety.

### TECHNICAL FIELD

The present disclosure relates generally to methods and compositions for modulating the metabolite content of fruits and vegetables, and more particularly to the use of acetohydroxyacid synthase inhibitors to alter flavor related metabolites.

### BACKGROUND

Fruits and vegetables produce a wide array of branched-chain metabolites that strongly influence flavor and aroma. A survey of 107 fruit species revealed at least 127 distinct branched-chain metabolites spanning “fruity,” “floral,” “green,” and “musky” sensory notes. Commercially important commodities such as banana, mango, apple, pear and cantaloupe each emit on the order of twenty or more of these compounds. While many branched-chain metabolites are desirable, certain members of this family impart objectionable flavors. Of particular concern are methoxypyrazines, trace constituents concentrated in grape peel tissues that confer a pronounced “green bell pepper” character to red wines. Because methoxypyrazines possess extremely low odor thresholds, even minute quantities can dominate a product's aroma and markedly reduce consumer appeal. At present there are no acceptable physical or chemical post-harvest methods for selectively reducing or removing off-flavor compounds such as methoxypyrazines.

### SUMMARY

Application of acetohydroxyacid synthase (AHAS) inhibitors to fruits and vegetables inhibits the biosynthesis of branched-chain amino acids (isoleucine, leucine, and valine) and reduces the levels of downstream branched-chain metabolites including branched-chain α-ketoacids, branched-chain alcohols, and branched-chain esters. In that branched-chain esters are odor-active volatiles, this allows for the targeted alteration of flavor via application of the inhibitors. Any metabolite whose biosynthesis depends upon AHAS can likewise be reduced.

Methods of reducing one or more branched-chain metabolites in a plant part comprising contacting the plant part with a composition comprising an AHAS inhibitor are provided. Methods of altering the flavor of a fruit or vegetable comprising contacting the fruit or vegetable with a composition comprising an AHAS inhibitor are also provided.

Methods of reducing one or more methoxypyrazines in grapes or a grape product comprising contacting the grapes with a composition comprising an AHAS inhibitor are provided. Methods of producing wine with an altered flavor comprising contacting grapes with a composition comprising an AHAS inhibitor and producing a wine from the grapes are also provided.

Treatment compositions for fruits or vegetables comprising an AHAS inhibitor and one or more agriculturally acceptable auxiliaries are also provided. Plant parts having a composition of the disclosure comprising an AHAS inhibitor applied to the surface are also provided.

### BRIEF DESCRIPTION OF THE FIGURES

The following drawings form part of the specification and are included to further demonstrate certain embodiments. In some instances, embodiments can be best understood by referring to the accompanying figures in combination with the detailed description presented herein. The description and accompanying figures may highlight a certain specific example, or a certain embodiment. However, one skilled in the art will understand that portions of the example or embodiment may be used in combination with other examples or embodiments.

FIG. 1 shows the branched-chain amino acid biosynthesis and the citramalate synthase pathway. Reactions shown as solid arrows, those understood to be freely reversible are depicted with double-ended arrows. Abbreviated pathways shown with dashed arrows. Enzymes shown in curved boxes. Principal inhibitory interactions drawn with dashed lines. Minor inhibitory mechanisms not shown: antagonism of isoleucine feedback at TD by valine, and inhibition of AHAS by isoleucine. Note that of the fruits discussed herein, CMS has only been identified in apple. α-Ketocaproate elongation via CMS has not been observed in apple fruits. AHAS=acetohydroxyacid synthase (also known as acetolactate synthase), BCAT=branched-chain aminotransferase, CMS=citramalate synthase, DHAD=dihydroxyacid dehydratase, IPMDH=isopropylmalate dehydrogenase, IPMI=isopropylmalate isomerase, IPMS=isopropylmalate synthase, KARI=ketol-acid reductoisomerase, TD=threonine deaminase.

FIG. 2 shows a simplified, hypothetical routes of fruit volatile ester precursor biogenesis. Precursors of anteiso- and iso-branched-chain esters are potentially supplied by preexisting sources and/or de novo synthesis. The latter can be arrested by application of acetohydroxyacid synthase (AHAS) inhibitors, allowing for assessment of precursor pathway contributions.

FIG. 3A-B shows representative total ion chromatogram sections from incubation chamber headspace of apple and banana fruit tissues treated with water or an acetohydroxyacid synthase inhibitor. Anteiso- and iso-branched-chain esters indicated in italics. FIG. 3A shows ‘Jonagold’ apple fruit peels treated with water or rimsulfuron and fed methanol. FIG. 3B shows ‘Valery’ banana fruit pulp sections treated with water or halosulfuron-methyl. 1MByl=1-methylbutyl, 2MBate=2-methylbutanoate, 2MByl=2-methylbutyl, 2MPyl=2-methylpropyl, 3MByl=3-methylbutyl.

FIG. 4 shows fruit headspace and peel tissue content of anteiso-branched-chain esters and their precursors, respectively, of ripe ‘Red Delicious’ apple fruit treated with rimsulfuron over time. 2-Methylbutanoate ester content is the sum of ethyl 2-methylbutanoate, butyl 2-methylbutanoate, and hexyl 2-methylbutanoate. Treatment period was from d 1-3. Ratios calculated by comparing rimsulfuron-treated samples against average of controls on said day or, for initial samples, against average of all samples. All means were found to be significantly different except for headspace content and ratio of 2-methylbutanoate esters on d 1 (two-tailed for esters, one-tailed for acids, two-sample equal variance t-test for metabolite content; two-tailed one-sample t-test for ratios; α=0.05). Data presented as means±SE of ≥three biological replicates.

FIG. 5A-D shows the effects of rimsulfuron on anteiso- and iso-branched-chain ester headspace content in fruit and complementation with precursors. FIG. 5A shows ripening ‘Empire’ apple fruit. FIG. 5B shows ripening ‘Jonagold’ apple fruit. FIG. 5C shows ripe ‘Red Delicious’ apple fruit. Feedings performed on day seven of time course and measured the next day. FIG. 5D shows ripening ‘Valery’ banana fruit. 2-Methylbutanoate ester content is the sum of ethyl 2-methylbutanoate, butyl 2-methylbutanoate, and hexyl 2-methylbutanoate. α-KMV=α-keto-β-methylvalerate, α-KIV=α-ketoisovalerate, α-KIC=α-ketoisocaproate. Significantly different headspace concentrations are denoted by different letters adjacent to means (data transformed (log(x+1)) for statistical analysis due to unequal variance of fed samples; Tukey's test, α=0.05). Data presented as means±SE of ≥three biological replicates.

### DETAILED DESCRIPTION

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation; the preferred materials and methods are described herein. In describing and claiming the embodiments of the present disclosure, the following terminology will be used in accordance with the definitions set out below.

It is to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Similarly, the word “or” is intended to include “and” unless the context clearly indicates otherwise. The word “or” means any one member of a particular list and also includes any combination of members of that list. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

The term “about”, as used herein, refers to variation in the numerical quantity that can occur, for example, through typical measuring techniques and equipment, with respect to any quantifiable variable, including, but not limited to, mass, volume, time, and temperature. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

In physiology, it is understood that only five sensory perceptions are discernible by the mouth in general and the tongue in particular, sweetness, saltiness, sourness, bitterness, and umami. All other sensory perceptions relating to taste/flavor derive from odors sensed by olfactory sensors in the nasal cavity. Therefore, it is commonly accepted that “taste” refers only to the five sensory perceptions that are discernible by the mouth and tongue, i.e., sweetness, saltiness, sourness, bitterness, and umami while “flavor” refers to the overall sensory perception derived from the combination of the taste sensory perceptions produced in the mouth plus the odor sensory perceptions produced in the nasal cavity. That same conventional usage of “taste” and “flavor” is used in this disclosure as well.

As used herein, the term “grape juice” is used to refer to juice prepared from grapes including, for example, grapes cultivated for wine production.

As used herein, the term “wine” is used to describe a product resulting from an alcoholic fermentation of juice or must of grapes or of any other fruit or berries, whether the fermentation occurs spontaneously or it is obtained by the addition of a yeast culture.

Application of acetohydroxyacid synthase (AHAS) inhibitors to fruits and vegetables inhibits the biosynthesis of branched-chain metabolites that are precursors to branched-chain amino acids (isoleucine, leucine, and valine) and branched-chain esters. In that branched-chain esters are odor-active volatiles, this allows for the targeted alteration of flavor via application of the inhibitors.

Thus, the present disclosure relates to a method of reducing one or more branched-chain metabolites in a plant part comprising contacting the plant part with a composition comprising an AHAS inhibitor. The disclosure also relates a method of altering the flavor of a fruit or vegetable comprising contacting the fruit or vegetable with a composition comprising an AHAS inhibitor.

Acetohydroxyacid synthase (AHAS), also known as acetolactate synthase (ALS), is an enzyme found in plants and microorganisms. AHAS catalyzes the first step in the synthesis of branched-chain amino acids such as valine, leucine, isoleucine.

AHAS inhibitor herbicides (AHAS inhibitors) are herbicidally active compounds which inhibit the branched-chain amino acid biosynthesis. They belong to group B of the HRAC classification system. This inhibitor class has broad effectiveness. Treatments were successfully performed on fruit species as diverse as apple fruit (dicotyledonous, temperate, & deciduous) and banana fruit (monocotyledonous, tropical, & herbaceous). The treatments were capable of modulating both high- and low-abundance metabolites. The chemicals used are inodorous and of low risk to humans such that routine postharvest washes suffice to remove trace residues.

In certain embodiments, the AHAS inhibitor comprises one or more of an imidazolinone, a sulfonylurea, a triazolopyrimidine, a pyrimidinyl benzoate, or a sulfonylamino carbonyl triazolinone, or any mixture of the foregoing including agriculturally acceptable salts or derivatives thereof.

Non-limiting examples of AHAS inhibitors include imidazolinones such as imazamethabenz, imazamethabenz-methyl, imazamox, imazapic, imazapyr, imazaquin and imazethapyr; sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, iofensulfuron, iofensulfuron-sodium, mesosulfuron, metazosulfuron, metsulfuron, metsulfuron-methyl, nicosulfuron, orthosulfamuron, oxasulfuron, primisulfuron, primisulfuron-methyl, propyrisulfuron, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron; triazolopyrimidines and sulfonanilides such as cloransulam, cloransulam-methyl, diclosulam, flumetsulam, florasulam, metosulam, penoxsulam, pyrimisulfan and pyroxsulam and triafamone; pyrimidinyl benzoates (thiobenzoates and oxybenzoates) such as bispyribac, bispyribac-sodium, pyribenzoxim, pyriftalid, pyriminobac, pyriminobac-methyl, pyrithiobac, pyrithiobacsodium, 4-[[[2-[(4,6-dimethoxy-2-10 pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5), N-(4-bromophenyl)-2-[(4,6-di-methoxy-2-pyrimidinyl)oxy]benzenemethanamine (CAS 420138-01-8); and sulfonylaminocarbonyl-triazolinones such as flucarbazone, flucarbazone-sodium, propoxycarbazone, propoxycarbazone-sodium, thiencarbazone and thiencarbazone-methyl; or any mixture of the foregoing.

The composition may further comprise at least one agriculturally acceptable auxiliary. Suitable agriculturally acceptable auxiliaries include, but are not limited to, extenders, solvents, carriers, emulsifiers, dispersants, thickeners, and adjuvants.

A carrier is a solid or liquid, natural or synthetic, organic or inorganic substance that is generally inert. The carrier generally improves the application of the compounds, for instance, to plants or plants parts. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks. Examples of suitable liquid carriers include, but are not limited to, water, organic solvents and combinations thereof. Examples of suitable solvents include polar and nonpolar organic chemical liquids, for example from the classes of aromatic and nonaromatic hydrocarbons (such as cyclohexane, paraffins, alkylbenzenes, xylene, toluene, tetrahydronaphthalene, alkylnaphthalenes, chlorinated aromatics or chlorinated aliphatic hydrocarbons such as chlorobenzenes, chloroethylenes or methylene chloride), alcohols and polyols (which may optionally also be substituted, etherified and/or esterified, such as ethanol, propanol, propylene glycol, butanol, benzylalcohol, cyclohexanol or glycol), ketones (such as acetone, methyl ethyl ketone, methyl isobutyl ketone or cyclohexanone), esters (including fats and oils) and (poly) ethers, unsubstituted and substituted amines, amides (such as dimethylformamide or fatty acid amides) and esters thereof, lactams (such as N-alkylpyrrolidones, in particular N-methylpyrrolidone) and lactones, sulfones and sulfoxides (such as dimethyl sulfoxide), oils of vegetable or animal origin. The carrier may also be a liquefied gaseous extender, i.e. liquid which is gaseous at standard temperature and under standard pressure, for example aerosol propellants such as halohydrocarbons, butane, propane, nitrogen and carbon dioxide.

The surfactant can be an ionic (anionic or cationic), amphoteric, or non-ionic surfactant, such as ionic or non-ionic emulsifiers, foam formers, dispersants, wetting agents, penetration enhancers, and any mixtures thereof.

Examples of anionic surfactants and classes of anionic surfactants suitable for use in the practice of the present disclosure include: alcohol sulfates; alcohol ether sulfates; alkylaryl ether sulfates; alkylaryl sulfonates such as alkylbenzene sulfonates and alkylnaphthalene sulfonates and salts thereof; alkyl sulfonates; mono- or di-phosphate esters of polyalkoxylated alkyl alcohols or alkylphenols; mono- or di-sulfosuccinate esters of C₁₂ to C₁₅ alkanols or polyalkoxylated C₁₂ to C₁₅ alkanols; alcohol ether carboxylates; phenolic ether carboxylates; polybasic acid esters of ethoxylated polyoxyalkylene glycols consisting of oxybutylene or the residue of tetrahydrofuran; sulfoalkylamides and salts thereof such as N-methyl-N-olcoyltaurate Na salt; polyoxyalkylene alkylphenol carboxylates; polyoxyalkylene alcohol carboxylates alkyl polyglycoside/alkenyl succinic anhydride condensation products; alkyl ester sulfates; naphthalene sulfonates; naphthalene formaldehyde condensates; alkyl sulfonamides; sulfonated aliphatic polyesters; sulfate esters of styrylphenyl alkoxylates; and sulfonate esters of styrylphenyl alkoxylates and their corresponding sodium, potassium, calcium, magnesium, zinc, ammonium, alkylammonium, diethanolammonium, or triethanolammonium salts; salts of ligninsulfonic acid such as the sodium, potassium, magnesium, calcium or ammonium salt; polyarylphenol polyalkoxyether sulfates and polyarylphenol polyalkoxyether phosphates; and sulfated alkyl phenol ethoxylates and phosphated alkyl phenol ethoxylates; sodium lauryl sulfate; sodium laureth sulfate; ammonium lauryl sulfate; ammonium laureth sulfate; sodium methyl cocoyl taurate; sodium lauroyl sarcosinate; sodium cocoyl sarcosinate; potassium coco hydrolyzed collagen; TEA (triethanolamine) lauryl sulfate; TEA (Triethanolamine) laureth sulfate; lauryl or cocoyl sarcosine; disodium oleamide sulfosuccinate; disodium laureth sulfosuccinate; disodium dioctyl sulfosuccinate; N-methyl-N-oleoyltaurate Na salt; tristyrylphenol sulphate; ethoxylated lignin sulfonate; ethoxylated nonylphenol phosphate ester; calcium alkylbenzene sulfonate; ethoxylated tridecylalcohol phosphate ester; dialkyl sulfosuccinates; perfluoro (C₆-C₁₈)alkyl phosphonic acids; perfluoro(C₆-C₁₈)alkyl-phosphinic acids; perfluoro(C₃-C₂₀)alkyl esters of carboxylic acids; alkenyl succinic acid diglucamides; alkenyl succinic acid alkoxylates; sodium dialkyl sulfosuccinates; and alkenyl succinic acid alkylpolyglycosides.

Examples of amphoteric and cationic surfactants include alkylpolyglycosides; betaines; sulfobetaines; glycinates; alkanol amides of C₈ to C₁₈ fatty acids and C₈ to C₁₈ fatty amine polyalkoxylates; C₁₀ to C₁₈ alkyldimethylbenzylammonium chlorides; coconut alkyldimethylaminoacetic acids; phosphate esters of C₈ to C₁₈ fatty amine polyalkoxylates; alkylpolyglycosides (APG) obtainable from an acid-catalyzed Fischer reaction of starch or glucose syrups with fatty alcohols, in particular C₈ to C₁₈ alcohols, especially the C₈ to C₁₀ and C₁₂ to C₁₄ alkylpolyglycosides having a degree of polymerization of 1.3 to 1.6, in particular 1.4 or 1.5.

Examples of non-ionic surfactants and classes of non-ionic surfactants include: polyarylphenol polyethoxy ethers; polyalkylphenol polyethoxy ethers; polyglycol ether derivatives of saturated fatty acids; polyglycol ether derivatives of unsaturated fatty acids; polyglycol ether derivatives of aliphatic alcohols; polyglycol ether derivatives of cycloaliphatic alcohols; fatty acid esters of polyoxyethylene sorbitan; alkoxylated vegetable oils; alkoxylated acetylenic diols; polyalkoxylated alkylphenols; fatty acid alkoxylates; sorbitan alkoxylates; sorbitol esters; C₈ to C₂₂ alkyl or alkenyl polyglycosides; polyalkoxy styrylaryl ethers; alkylamine oxides; block copolymer ethers; polyalkoxylated fatty glyceride; polyalkylene glycol ethers; linear aliphatic or aromatic polyesters; organo silicones; polyaryl phenols; sorbitol ester alkoxylates; and mono- and diesters of ethylene glycol and mixtures thereo; ethoxylated tristyrylphenol; ethoxylated fatty alcohol; ethoxylated lauryl alcohol; ethoxylated castor oil; and ethoxylated nonylphenol; alkoxylated alcohols, amines or acids, mixtures thereof as well as mixtures thereof with diluents and solid carriers, in particular clathrates thereof with urea. The alkoxylated alcohols, amines or acids are preferably based on alkoxy units having 2 carbon atoms, thus being a mixed ethoxylate, or 2 and 3 carbon atoms, thus being a mixed ethoxylate/propoxylated, and having at least 5 alkoxy moieties, suitably from 5 to 25 alkoxy moieties, preferably 5 to 20, in particular 5 to 15, in the alkoxy chain. The aliphatic moieties of the amine or acid alkoxylated may be straight chained or branched of 9 to 24, preferably 12 to 20, carbon atoms. The alcohol moiety of the alcohol alkoxylates is as a rule derived from a C₉-C₁₈ aliphatic alcohol, which may be non-branched or branched, especially monobranched.

The aforementioned surfactants may be used alone or in combination. All of these surfactant materials are well known and commercially available.

Further examples of suitable auxiliaries include water repellents, siccatives, binders (adhesive, tackifier, fixing agent, such as carboxymethylcellulose, natural and synthetic polymers in the form of powders, granules or latices, such as gum arabic, polyvinyl alcohol and polyvinyl acetate, natural phospholipids such as cephalins and lecithins and synthetic phospholipids, polyvinylpyrrolidone and tylose), thickeners and secondary thickeners (such as cellulose ethers, acrylic acid derivatives, xanthan gum, modified clays, e.g. the products available under the name Bentone, and finely divided silica), stabilizers (e.g. cold stabilizers, preservatives (e.g. dichlorophen and benzyl alcohol hemiformal), antioxidants, light stabilizers, in particular UV stabilizers, or other agents which improve chemical and/or physical stability), dyes or pigments (such as inorganic pigments, e.g. iron oxide, titanium oxide and Prussian Blue; organic dyes, e.g. alizarin, azo and metal phthalocyanine dyes), antifoams (e.g. silicone antifoams and magnesium stearate), antifreezes, stickers, mineral and vegetable oils, perfumes, waxes, nutrients (including trace nutrients, such as salts of iron, manganese, boron, copper, cobalt, molybdenum and zinc), protective colloids, thixotropic substances, penetrants, sequestering agents, and complex formers.

The choice of the auxiliaries depends on the intended mode of application. Furthermore, the auxiliaries may be chosen to impart particular properties to the compositions or use forms prepared therefrom. The choice of auxiliaries may allow customizing the compositions to specific needs.

The composition may be provided to the end user as ready-for-use formulation, i.e. the compositions may be directly applied to the plant or plant part by a suitable device, such as a spraying or dusting device. Alternatively, the compositions may be provided to the end user in the form of concentrates which have to be diluted prior to use. The method of application such as spraying, dusting atomizing, dispersing, dipping, coating, and the like may be chosen based on the nature of the composition to be applied, when it is to be applied, e.g., pre-harvest or post-harvest, and the plant or plant part to which it is to be applied.

In certain embodiments, the composition is applied as a one-time treatment to a plant or a plant part thereof. In certain embodiments, multiple sequential applications are performed. In certain embodiments, the composition is applied once per day for two, three, four, five, six, seven, eight, nine, ten, or more consecutive days. In certain embodiments, the composition is applied once per week, two times per week, three times per week, four times per week, or five time per week for one week or for two, three, four, five, six, seven, eight, nine, ten, or more consecutive weeks. In certain embodiments, the composition is applied pre-harvest. In certain embodiments, the composition is applied post-harvest.

In certain embodiments, the AHAS inhibitor is applied at an effective dosage sufficient to reduce at least one branched-chain metabolite. In certain embodiments, the concentration of active ingredient may be at least about 0.01 mM, about 0.05 mM, about 0.1 mM, about 0.25 mM, about 0.5 mM, or about 1 mM. In certain embodiments, the concentration of active ingredient may be no greater than or less than about 10 mM, about 5 mM, about 1 mM, about 0.5 mM, about 0.25 mM, about 0.1 mM, or about 0.05 mM. One of ordinary skill in the art will recognize that these ranges may be adjusted to accommodate different AHAS inhibitors, the type of fruit or vegetable, and the degree of flavor modulation desired.

In certain embodiments, the reduction in the branched-chain metabolite is at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%. In certain embodiments, the reduction in the branched-chain metabolite is by at least about 1.0-fold, at least about 1.5-fold, at least about 2.0-fold, at least about 2.5-fold, at least about 3.0-fold, at least about 3.5-fold, at least about 4.0-fold, at least about 5.0-fold, at least about 6.0-fold, at least about 7.0-fold, at least about 8.0-fold, at least about 9.0-fold, at least about 10-fold, or more than 10-fold.

This disclosure can be used for treating any type of plant part including, but not limited to, fruits and vegetables.

Examples of particular fruit that can be treated in accordance with this disclosure include, but are not limited to, apples, apricots, avocadoes, pears, Asian pears, cherries, strawberries, plums, peaches, nectarines, grapes, melons (including watermelon, cantaloupe, honey dew melon, muskmelon, etc.), guava, dates, figs, apricots, kiwi, citrus fruit (including lemons, limes, grapefruit, oranges, tangelos, kumquats, ugli fruit, mandarin oranges, Satsuma oranges, etc.), plums, mango, bananas, passion fruit, pineapple, cranberries, blueberries, raspberries, blackberries, cherries, papaya, coconut, and jackfruit.

Examples of particular vegetables that can be treated in accordance with this disclosure include, but are not limited to, arugula, asparagus, beets, bell peppers, bok choy, broccoli, Brussels sprouts, cabbage, carrots, cauliflower, celery, collard greens, corn, cucumbers, dandelion greens, eggplant, garlic, green beans, green peas, kale, leeks, mushrooms, mustard greens, okra, olives, onions, parsnips, potatoes, pumpkin, romaine lettuce, spinach, squash, summer, squash, winter, sweet potatoes, Swiss chard, turnip greens, watercress, yams, zucchini, and Jicama.

A target of particular interest is the class of odor-active compounds known as methoxypyrazines. These trace compounds are present in peel tissues of grapes and imbue red wines with undesirable ‘green bell pepper’ flavor. Methoxypyrazines are derived from branched-chain metabolites whose biosynthesis is dependent upon AHAS. Importantly, there are currently no acceptable physical or chemical methods of removal or reduction of these compounds. As a result, the wine industry has been forced to alter viticulture and enology practices in attempts to limit or mask the impact of these compounds to the final flavor. Treatment of maturing grapes with the compositions of the disclosure reduces the content of these deleterious compounds. Important methoxypyrazines found in grapes include 3-isobutyl-2-methoxypyrazine (IBMP), 3-sec-butyl-2-methoxypyrazine (SBMP), and 3-isopropyl-2-methoxypyrazine (IPMP).

Thus, the present disclosure also relates to a method of reducing one or more methoxypyrazines in grapes or a grape product comprising contacting the grapes with a composition comprising an AHAS inhibitor. The disclosure also relates a method of producing wine with an altered flavor comprising contacting grapes with a composition comprising an AHAS inhibitor and producing a wine from the grapes.

Wines that may be produced using the methods of the present disclosure include red wines, white wines, and rose wines, or sparkling wine versions thereof. In certain embodiments, the wine is a red wine. Wines of the present disclosure may be all of one grape varietal, or may include wines of different types of grapes. Wine grape varieties represent only a small portion of the more than 600 kinds of grapes. Each grape variety has its own unique combination of characteristics including color, size, skin thickness, acidity, yield per vine, and flavor. Those of ordinary skill in the art may select the appropriate grape to produce the desired type of wine of the present disclosure. Red wines include, but are not limited to, those derived by fermentation of one or more of the following varietals of grapes: Pinot Noir, Merlot, Zinfandel, Cabernet Sauvignon, Syrah, Shiraz, Petite Syrah, Sangiovese, Barbera, Barbarossa, Brunello, Cabernet Franc, Carignane, Carmenere, Cinsault, Dolcetto, Durif, Gamay, Gamay Noir, Gamay Beaujolais, Grenache, Grignolino, Malbec, Montepulciano, Mourvedre, Muscat, Nebbiolo, Petite Sirah, Petit Verdot, Pinotage, Pinot Meunier, Tempranillo, Tinta Barroca, Tinta Cau, Touriga, Francesa, Touriga Nacional, and Tinta Roriz. The listing of varietals is not intended to be exhaustive, and merely provides examples of grapes that may be used in the present disclosure.

In certain embodiments, the reduction in the methoxypyrazine is at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 96%, at least about 97%, at least about 98%, or at least about 99%. In certain embodiments, the reduction in the methoxypyrazine is by at least about 1.0-fold, at least about 1.5-fold, at least about 2.0-fold, at least about 2.5-fold, at least about 3.0-fold, at least about 3.5-fold, at least about 4.0-fold, at least about 5.0-fold, at least about 6.0-fold, at least about 7.0-fold, at least about 8.0-fold, at least about 9.0-fold, at least about 10-fold, or more than 10-fold.

### Embodiments

The following numbered embodiments also form part of the present disclosure:
1. A method of reducing one or more branched-chain metabolites in a plant part, the method comprising: contacting the plant part with a composition comprising an acetohydroxyacid synthase (AHAS) inhibitor.
2. The method of embodiment 1, wherein the plant part is a harvested plant part.
3. The method of embodiment 1 or embodiment 2, wherein the plant part is a fruit or vegetable.
4. The method of any one of embodiments 1-3, wherein the AHAS inhibitor comprises an imidazolinone, a sulfonylurea, a triazolopyrimidine, a pyrimidinyl benzoate, or a sulfonylamino carbonyl triazolinone.
5. A method of altering the flavor of a fruit or vegetable, the method comprising: contacting the fruit or vegetable with a composition comprising an AHAS inhibitor.
6. The method of embodiment 5, wherein the fruit or vegetable is a harvested fruit or vegetable.
7. The method of embodiment 5 or embodiment 6, wherein the fruit or vegetable is an apple, banana, melon, grape, mango, or pear.
8. The method of any one of embodiments 5-7, wherein the AHAS inhibitor comprises an imidazolinone, a sulfonylurea, a triazolopyrimidine, a pyrimidinyl benzoate, or a sulfonylamino carbonyl triazolinone.
9. The method of any one of embodiments 5-8, wherein one or more branched-chain metabolites are reduced in the fruit or vegetable.
10. A method of reducing one or more methoxypyrazines in grapes or a grape product, the method comprising: contacting the grapes with a composition comprising an AHAS inhibitor.
11. The method of embodiment 10, further comprising producing the grape product from the grapes.
12. The method of embodiment 10 or embodiment 11, wherein the grape product is grape juice or wine.
13. The method of any one of embodiments 10-12, wherein the AHAS inhibitor comprises an imidazolinone, a sulfonylurea, a triazolopyrimidine, a pyrimidinyl benzoate, or a sulfonylamino carbonyl triazolinone.
14. A method of producing wine with an altered flavor, the method comprising: contacting grapes with a composition comprising an AHAS inhibitor; and producing a wine from the grapes.
15. The method of embodiment 14, wherein the altered flavor comprises reduced green character.
16. The method of embodiment 14 or embodiment 15, wherein one or more methoxypyrazines are reduced in the wine.
17. The method of any one of embodiments 14-16, wherein the wine is a red wine.
18. The method of any one of embodiments 14-17, wherein the AHAS inhibitor comprises an imidazolinone, a sulfonylurea, a triazolopyrimidine, a pyrimidinyl benzoate, or a sulfonylamino carbonyl triazolinone.
19. A treatment composition for fruits or vegetables comprising an AHAS inhibitor; and one or more agriculturally acceptable auxiliaries.
20. The composition of embodiment 19, wherein the AHAS inhibitor comprises an imidazolinone, a sulfonylurea, a triazolopyrimidine, a pyrimidinyl benzoate, or a sulfonylamino carbonyl triazolinone.
21. The composition of embodiment 19 or embodiment 20, wherein the one or more agriculturally acceptable auxiliaries comprise an extender, solvent, carrier, emulsifier, dispersant, thickener, or adjuvant.
22. A plant part having a composition applied to the surface, wherein the composition comprises an acetohydroxyacid synthase (AHAS) inhibitor.
23. The plant part of embodiment 22, wherein the plant part is a harvested plant part.
24. The plant part of embodiment 22 or embodiment 23, wherein the plant part is a fruit or vegetable.
25. The plant part of any one of embodiments 22-24, wherein the fruit or vegetable is an apple, banana, melon, grape, mango, or pear.
26. The plant part of any one of embodiments 22-25, wherein the AHAS inhibitor comprises an imidazolinone, a sulfonylurea, a triazolopyrimidine, a pyrimidinyl benzoate, or a sulfonylamino carbonyl triazolinone.
27. The plant part of any one of embodiments 22-26, wherein the composition comprises one or more agriculturally acceptable auxiliaries.
28. The plant part of any one of embodiments 22-27, wherein the one or more agriculturally acceptable auxiliaries comprise an extender, solvent, carrier, emulsifier, dispersant, thickener, or adjuvant.

All publications and patent applications are herein incorporated by reference to the same extent as if each individual publication or patent application was specifically and individually indicated to be incorporated by reference.

Although the foregoing disclosure has been described in some detail by way of illustration and example for purposes of clarity of understanding, it will be obvious that certain changes and modifications may be practiced within the scope of the appended claims.

The following examples are offered by way of illustration and not by way of limitation.

### EXAMPLES

### Example 1: Fruit Produce Branched-Chain Esters Primarily from Newly Synthesized Precursors

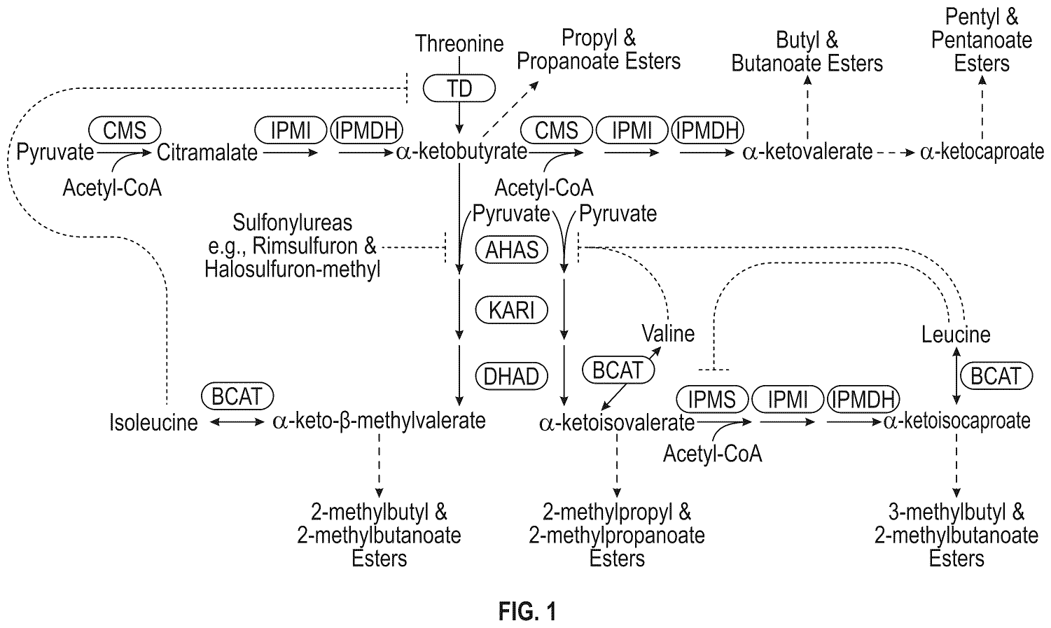

For over half a century, a relationship has been known to exist between the branched-chain esters, which act as impact flavor notes for many popular fruits, and branched-chain amino acids. Specifically, feeding studies have demonstrated an interchange of labeled carbons between exogenously fed branched-chain amino acids and emanated branched-chain esters, linking 2-methylbutyl and 2-methylbutanote esters to isoleucine metabolism, 2-methylpropyl and 2-methylpropanoate esters to valine metabolism, and 3-methylbutyl and 3-methylbutanoate esters to leucine metabolism (FIG. 1). While substantial effort has been given to understand the conversion of branched-chain amino acids and their respective α-ketoacids into esters, the means that fruit use to supply said precursors has never been directly investigated. Despite this lack of concrete evidence, it has regularly been stated or implied that branched-chain aroma biosynthesis is sourced by catabolic means—seemingly inferred from the above-mentioned feeding experiments.

Ripening in fruit is a dynamic process involving sequentially induced modifications to many metabolic processes. It would seem inconsistent to suggest that autonomous aroma biosynthesis, the often-terminal feature of ripening and thus the ultimate attractant for consumption and seed dispersal, is not also an actively regulated and developmentally controlled process. It was hypothesized that the entirety of autonomous ester formation is under programmed regulation and, thus, it was proposed that branched-chain esters are derived from newly synthesized precursors via anabolic processes, rather than catabolic processes.

The metabolites that directly link primary and specialized metabolism for branched-chain ester production are the branched-chain α-ketoacids (FIG. 1). The quantity of branched-chain α-ketoacids reflects the quantity of the branched-chain amino acids because transamination between the two, facilitated by branched-chain aminotransferases, is freely reversible. While the amino acids are more routinely measured and exogenously applied to fruits than the α-ketoacids, the branched-chain α-ketoacids are the more direct precursors to branched-chain esters. However, as the following research was principally concerned with processes that are upstream from the conversion of α-ketoacids into esters, the branched-chain amino acids and α-ketoacids were collectively considered as a precursor pool for branched-chain ester biosynthesis herein.

There are several lines of evidence that indirectly support the de novo synthesis of branched-chain esters. Among the free amino acids of ripening apple (Malusxdomestica Borkh.) and banana (Musa spp.) fruits, only those with related branched-chain volatiles produced by the fruit undergo a marked increase that is concomitant with aroma emanation (i.e., isoleucine in apple, and valine and leucine in banana). Catabolic processes would not be expected to produce such coincidental results, implying that these fruits are actively engaging the synthetic processes of branched-chain amino acids and α-ketoacids.

The importance of de novo precursor production in apple fruit has been further demonstrated through the elucidation of citramalate synthase's role in providing an alternative synthetic route that effectively circumvents isoleucine's feedback inhibition of threonine deaminase, and, in so doing, produces >80% of the precursor pool for 2-methylbutyl and 2-methylbutanoate ester production (FIG. 1). Apple cultivars that lack a catalytically active allele of citramalate synthase produce minimal quantities of said esters. The role of de novo precursor synthesis has likewise recently garnered greater consideration in other fruits as well, such as tomato and muskmelon.

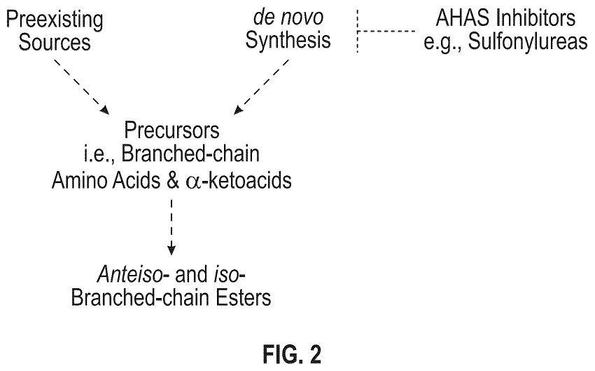

To further understanding of the source of ester precursors, a definitive determination was sought regarding whether branched-chain esters in fruit are made from preexisting amino acids and α-ketoacids and/or from those newly synthesized during ripening (FIG. 2). Apple and banana fruits were chosen as ideal testing materials due to 1) the relatively large proportion of branched-chain esters in their aroma profiles, 2) the availability of substantial descriptive biochemical data for the metabolites of interest, and 3) the diversity of adaptations and physiologies among climacteric fruits that they represent. To extend the inquiry to non-human-consumed fruits, ornamental flowering quince (Chaenomeles x superba), a little explored apple relative, was included.

It was hypothesized that if ester production is dependent upon anabolic precursor synthesis in ripening fruits, then targeted inhibition of the canonical biosynthetic pathway for branched-chain amino acids and α-ketoacids should simultaneously prevent the accumulation of said compounds as well as their downstream metabolites, including branched-chain esters. On the other hand, if the branched-chain amino acids and α-ketoacids utilized in aroma biosynthesis are preexisting, such as being derived from protein degradation, then branched-chain ester synthesis should persist or be minimally disrupted by inhibition of de novo synthesis (FIG. 2).

### Results

### Experimental Philosophy and Methodology

Apples, flowering quince, and banana fruit were treated with inhibitors of acetohydroxyacid synthase (AHAS, also known as acetolactate synthase; FIG. 1, FIG. 2). AHAS is the common enzyme of branched-chain amino acid and α-ketoacid biosynthesis. It can be inhibited by compounds from a number of chemical families. Among them, sulfonylureas and imidazolinones have been determined to act by binding within and obstructing the substrate channel that leads to the active site of AHAS, resulting in a loss of catalytic activity. Given the lack of an alternative biosynthetic pathway, AHAS inhibition arrests de novo branched-chain α-ketoacid and amino acid biosynthesis, ultimately translating into severe inhibition of DNA synthesis, a halt of mitosis, and eventual plant death, hence their widespread application as commercial herbicides.

Treatment with AHAS inhibitors can lead to variable changes (including no change) of AHAS gene expression in different plant species/tissues. However, any potential transcriptional or translational changes are inconsequential as whatever AHAS present will be deactivated by inhibitor. Complementation with knocked-down ester precursors will assess whether other elements of the biochemical pathway have been compromised by toxic side effects.

When applying these inhibitors, fruit at or near the onset of ripening were intentionally selected for use (phrased as ‘ripening’) for most experimental runs. In these cases, treatment began prior to the accumulation of branched-chain amino acids. For apple, the peel is the primary site of aroma biogenesis and the location of greatest accumulation of branch-chain amino acid (i.e., isoleucine). For banana, the pulp is the primary source of branched-chain esters and the location of the greatest accumulation of branched-chain amino acids (i.e., valine and leucine). Using fruit at an early ripening stage catches the fruit before a substantial pool of branched-chain precursors have accumulated. To assess fruit that have already accumulated a supply of precursors, inhibitor was applied to ‘Red Delicious’ apple fruit of advanced ripeness (phrased as ‘ripe’).

Methodology trials with apple and banana fruits using sulfonylureas and imidazolinones led to marked decreases of the headspace content of anteiso- and iso-branched-chain esters. The replicated effects from the application of these distinct chemical families, as well as subsequent results from amino acid content analyses described herein, assured that these well-studied compounds were acting as inhibitors of AHAS, and that the observed results were not due to a fruit- or compound-specific idiosyncrasy. Further experimentation was performed with sulfonylureas.

### Apple

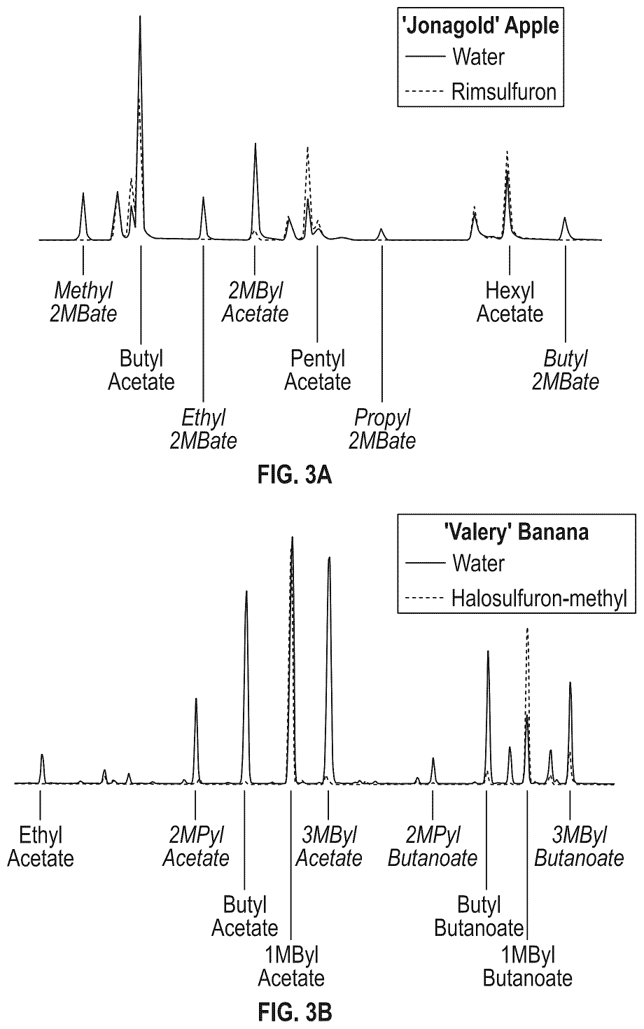

The application of rimsulfuron, a sulfonylurea AHAS inhibitor, led to the significant reduction of the total content of anteiso-branched-chain esters in the headspaces of ripening ‘Gala’, ‘Empire’, and ‘Jonagold’ apple fruits by 91.2% on average, with every 2-methylbutyl and 2-methylbutanoate ester analyzed having decreased (FIG. 3A, Table 1). Furthermore, 2-methylpropyl acetate, which is present in quantities under 2 nmol·L⁻¹ in the headspaces of all three cultivars, was also reduced following treatment. While rimsulfuron treatment had no discernible effect on butyl acetate, the concentration of pentyl acetate, on average, was 1.63-fold more abundant in all three of the cultivars when treated. No consistent pattern of change was observed of the other straight-chain esters.

Isoleucine was significantly reduced, on average, by 92.1% in the peels of ripening fruit for the three cultivars after rimsulfuron treatment (Table 2). Interestingly, among the other amino acids dependent upon AHAS for synthesis, valine was unaffected following treatment whereas the content of leucine increased, on average, 3.4-fold in the three ripening cultivars. Notably though, no other amino acid was reduced following treatment. While several were found to be somewhat elevated, no pattern of change among non-branched-chain amino acids was consistent across the ripening cultivars. Only ‘Gala’ fruit had a significant increase of total free amino acid content after treatment.

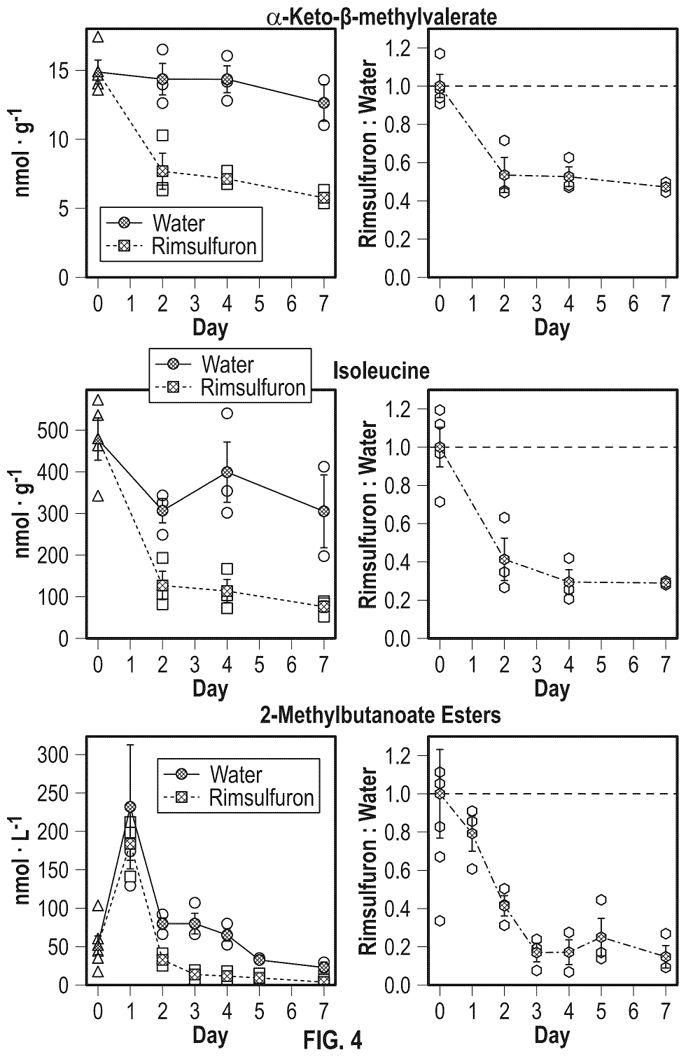

To help discern the metabolic flux of these processes, ripe fruit that had already accumulated a substantial pool of available precursors were treated with rimsulfuron. At the start of treatment the peel tissues of ripe ‘Red Delicious’ apple fruit used had nearly 500 nmol·g⁻¹, collectively, of isoleucine and its α-ketoacid, α-keto-β-methylvalerate (FIG. 4). Within two days of inhibitor application the content of these precursors had dropped considerably, eventually plateauing to 29.1% and 51.1% of control levels, respectively. The headspace content of 2-methylbutanoate esters likewise rapidly decreased to 15.0% of control fruits within three days of treatment. Thus, even ripe fruit that have amassed a substantial pool of precursors appear to rely heavily upon de novo replenishment of this evidently rapidly turned-over supply.

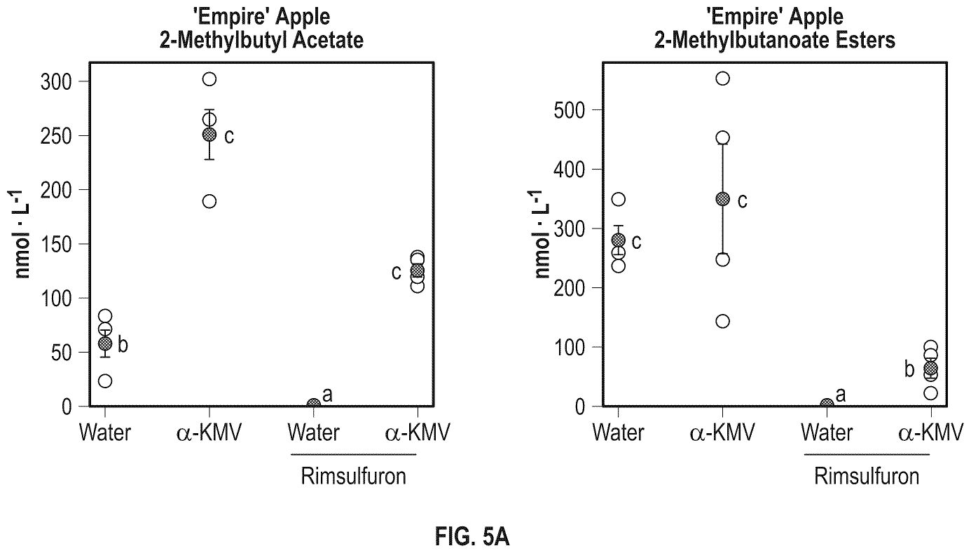

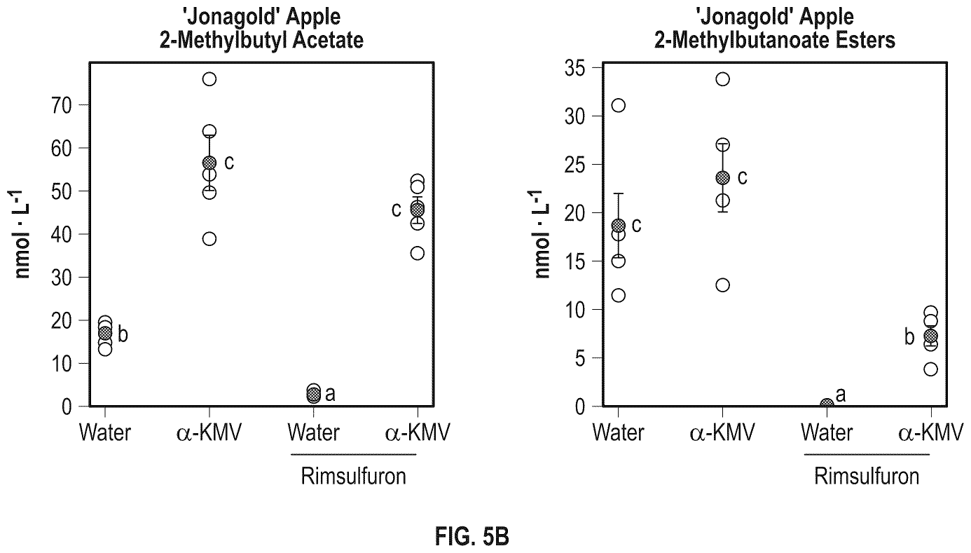

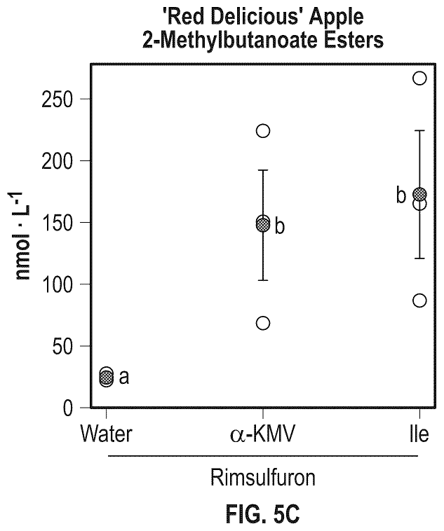

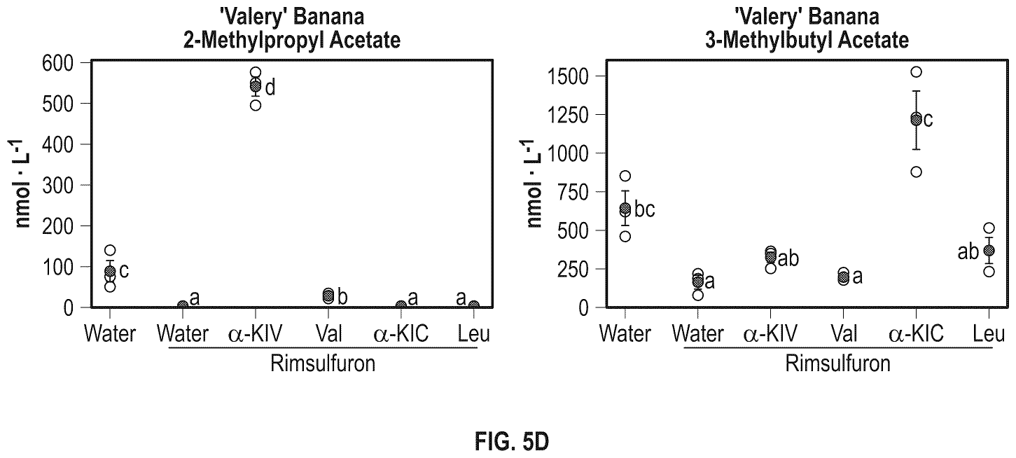

To determine if inhibitor-treated fruit were still capable of aroma production, branched-chain precursors were fed to the peel tissues of rimsulfuron and water-treated ripening ‘Empire’ and ‘Jonagold’, and ripe ‘Red Delicious’ apple fruit. Feedings of isoleucine or α-keto-β-methylvalerate to rimsulfuron-treated ripe ‘Red Delicious’ fruit peels resulted in recovery of anteiso-branched-chain esters (FIG. 5C). As both precursors were found to provide effective recovery of branched-chain esters, further feedings in apple were carried out with only the branched-chain α-ketoacids. In ripening ‘Jonagold’ and ‘Empire’ fruits, exogenous feeding of α-keto-β-methylvalerate led to at least a partial rescue of all 2-methylbutyl and 2-methylbutanoate esters of the rimsulfuron-treated fruit (FIG. 5A-B). Together, these results indicate ester synthesis capability was sustained in inhibitor-treated fruit and that reduced branched-chain ester levels were a result of precursor scarcity, not inhibitor toxicity.

‘Jonagold’ and ‘Empire’ peel tissues were also capable of converting exogenous α-ketoisovalerate and α-ketoisocaproate, the α-ketoacids of valine and leucine, respectively, into an abundance of their respective iso-branched-chain aldehydes, alcohols, alkyl ester moieties (those derived from alcohols) and alkanoate ester moieties (those derived from acyl-CoAs). None of these compounds are normally produced in appreciable quantities by apple fruit but are abundant in banana. Furthermore, activity of isopropylmalate synthase was evident by the observed emanation of 3-methylbutanal, 3-methylbutanol, and several 3-methylbutyl esters from fruit fed with α-ketoisovalerate (FIG. 1).

α-Keto-β-methylvalerate and α-ketoisovalerate were metabolized by both apple cultivars into similar molar concentrations of alkyl and alkanoate ester moieties. This is illustrated by the headspace concentrations of the respective ethyl and acetate esters of these α-ketoacids. Interestingly, α-ketoisocaproate was metabolized into substantially less alkanoate ester moieties than alkyl ones, indicating nuance within the intermediary enzymatic steps between the α-ketoacids and their respective esters.

To aid in discerning modified carbon flow following rimsulfuron treatment, labeled (1,2-¹³C2) acetate was fed to apple fruit in conjunction with methanol (which allows for methyl ester production and the analysis of only newly synthesized esters). The fed acetate is readily metabolized into acetyl-CoA, a substrate of citramalate synthase for the production of branched-chain and straight-chain ester precursors (FIG. 1).

Incorporation of labeled acetate into ‘Gala’ was poor, likely resulting from acetate already being saturated in the treated tissues, as has been hypothesized to occur in other cultivars. While sufficient incorporation was observed in ‘Empire’ and ‘Jonagold’ tissues, methyl 2-methylbutanoate content was reduced to such a considerable extent by inhibitor treatment (99.4% and 100%, respectively), that the resulting instrument responses were too low for reliable analysis of isotope enrichment shifts. Among straight-chain esters, the M+1 and M+2 methyl pentanoate isotopologs were collectively 4.28-fold more enriched in both cultivars, on average, after treatment. In ‘Jonagold’ fruit the M+1 isotopolog of methyl hexanoate also had slightly more enrichment than controls.

### Banana

The application of halosulfuron-methyl, another sulfonylurea AHAS inhibitor, caused a 90.3% reduction in the total content of iso-branched-chain esters in the headspace of ‘Valery’ banana fruit, with every iso-branched-chain ester and alcohol analyzed having decreased (FIG. 3B, Table 1). Surprisingly, ethyl acetate, butyl acetate, and butyl butanoate were also less in treated tissues (collectively reduced 95.0%). None of the sec-branched esters or their related volatiles (2-pentanone, 2-pentanol, 1-methylbutyl acetate, and 1-methylbutyl butanoate) were affected by inhibitor treatment.

Valine and leucine were significantly less abundant (by 57.6%) in halosulfuron-methyl-treated fruit whereas isoleucine levels were unchanged (Table 2). While no other amino acid was reduced in treated fruits, several were found to be higher after inhibitor treatment with the total content of free amino acids having increased.

Similar to the results in apple fruit, exogenous application of precursors to tissues treated with inhibitor led to a recovery of the iso-branched-chain esters (FIG. 5D), however the branched-chain α-ketoacids were considerably more effective than the amino acids. Banana fruit were also capable of metabolizing α-keto-β-methylvalerate into a variety of anteiso-branched-chain volatiles, as has been previously observed via the application of isoleucine. While supplementation with the depleted precursors failed to recover ethyl acetate, butyl acetate, or butyl butanoate in this reported trial, it should be noted that during method testing a marked recovery of ethyl acetate and butyl acetate was occasionally observed after α-ketoisocaproate application; further investigation is needed to better understand these observations.

### Flowering Quince

To demonstrate the reach of the hypothesis that de novo synthesis is a major contributor to branched-chain ester biosynthesis in ripening fruits, rimsulfuron was applied to the highly aromatic fruit of an essentially uninvestigated ornamental quince hybrid (Chaenomeles xsuperba, cv. Dr. Banks Pink).

The aroma profile of the small, dense fruit is dominated by the terpene linalool and the phenylpropene estragole, but low levels of the straight-chain esters propyl acetate, butyl acetate, and ethyl butanoate, as well as the branched-chain esters 2-methylpropyl acetate and 2-methylbutyl acetate are present. As this species is a member of Maleae (the tribe of Rosaceae that includes apples and pears), it was assumed that the peel is the site of aroma biogenesis. Thus, rimsulfuron was applied to the peels of aroma-active fruits and the effect upon aroma production and amino acid content was analyzed.

Rimsulfuron-treated fruits had 94.6% less 2-methylpropyl acetate and 2-methylbutyl acetate, but 22.7-fold more propyl acetate than untreated fruits. No difference was observed for butyl acetate, ethyl butanoate, estragole, or linalool (Table 1).

Valine and isoleucine were collectively reduced by 64.2% in rimsulfuron-treated peel tissue (Table 2). Leucine content was also reduced by 18.1% despite there being no leucine-related volatiles present in the headspace of the fruit. No other amino acid was diminished by inhibitor treatment. The total content of free amino acids was not significantly altered by treatment.

TABLE 1
Percent of acetate ester and total anteiso- and iso-branched-chain ester
emissions of sulfonylurea-treated fruit tissues compared to control.

| | | | | | flowering quince |
|---|---|---|---|---|---|
| | apple peel | | | banana pulp | peel |
| acetate ester | ‘Gala’ | ‘Empire’ | ‘Jonagold’ | ‘Valery’ | ‘Dr. Banks Pink’ |
| ethyl acetate | 57.7 ± 9.3 | 61.4 ± 7.9 | — | 3.9 ± 2.4 | . . . |
| propyl acetate | — | 53.8 ± 8.5 | — | . . . | 2265.0 ± 869.0 |
| butyl acetate | — | — | — | 3.9 ± 2.7 | — |
| pentyl acetate | 155.3 ± 17.5 | 161.9 ± 16.0 | 172.3 ± 20.2 | | |
| hexyl acetate | — | — | 162.7 ± 19.2 | . . . | |
| 1-methylbutyl acetate | | | | — | |
| 2-methylbutyl acetate (ile) | 27.0 ± 6.3 | 1.9 ± 0.6 | 16.1 ± 1.4 | | 5.2 ± 3.9 |
| 2-methylpropyl acetate (val) | 36.4 ± 5.0 | 27.3 ± 5.4 | 67.6 ± 4.1 | 2.0 ± 0.7 | 1.1 ± 1.4 |
| 3-methylbutyl acetate (leu) | | | | 10.4 ± 5.4 | |
| sum of anteiso- and iso- | 19.0 ± 4.5 | 0.8 ± 0.2 | 6.5 ± 0.5 | 9.7 ± 3.6 | 3.0 ± 2.4 |
| branched-chain esters | | | | | |

Percent presented if content of treated tissues significantly different (two-tailed two-sample equal variance t-test for apple and flowering quince, paired t-test for banana; α = 0.05). Presented as means ± SE of sulfonylurea-treated samples against average of controls for apple and flowering quince (unpaired samples), for banana as ratio of paired samples. Major anteiso- and iso-branched-chain esters highlighted in bold with related amino acid listed. Note that iso-branched-chain esters are normally present in near trace amounts in apple fruit aroma. Dash indicates no significant difference between treatments, ellipsis indicates present volatiles that were not quantified, blank indicates volatiles that are not present.

TABLE 2
Percent of free amino acid content of sulfonylurea-
treated fruit tissues compared to control.

| | | | | banana | flowering |
|---|---|---|---|---|---|
| | apple peel | | | pulp | quince peel |
| amino acid | ‘Gala’ | ‘Empire’ | ‘Jonagold’ | ‘Valery’ | ‘Dr. Banks Pink’ |
| alanine | 273.4 ± 27.4 | — | — | 407.4 ± 66.8 | — |
| arginine | — | — | — | — | — |
| asparagine | — | — | — | — | — |
| aspartate | 231.8 ± 18.0 | — | — | 332.7 ± 30.1 | — |
| cysteine | — | 261.5 ± 32.5 | 410.6 ± 49.6 | 264.2 ± 46.6 | — |
| glutamate | 146.3 ± 5.6 | — | — | 217.4 ± 23.9 | — |
| glutamine | 250.7 ± 33.5 | — | — | — | — |
| glycine | — | — | — | 173.1 ± 39.9 | — |
| histidine | — | — | — | — | 166.5 ± 20.1 |
| isoleucine | 16.4 ± 6.3 | 3.3 ± 0.7 | 4.1 ± 1.3 | — | 51.3 ± 9.1 |
| leucine | 214.4 ± 42.2 | 422.8 ± 100.1 | 393.2 ± 74.4 | 65.8 ± 6.1 | 81.9 ± 5.4 |
| lysine | — | — | — | — | — |
| methionine | — | 212.7 ± 26.8 | 218.3 ± 31.0 | — | 245.3 ± 38.5 |
| phenylalanine | — | — | — | — | — |
| proline | . . . | . . . | . . . | 188.4 ± 18.7 | . . . |
| serine | 300.1 ± 27.7 | — | 191.9 ± 32.1 | 186.2 ± 14.5 | 302.1 ± 32.0 |
| threonine | 182.3 ± 14.2 | — | — | — | — |
| tryptophan | — | — | — | — | — |
| tyrosine | — | — | — | 142.3 ± 25.1 | — |
| valine | — | — | — | 14.3 ± 0.8 | 28.1 ± 3.8 |
| total | 191.5 ± 20.4 | — | — | 150.6 ± 13.7 | |

Percent presented if content of treated tissues significantly different (two-sample equal variance t-test for apple and flowering quince, paired t-test for banana; one-tailed test for valine, leucine, and isoleucine; two-tailed test for all other amino acids; α = 0.05). Presented as means ± SE of sulfonylurea-treated samples against average of controls for apple and flowering quince (unpaired samples), for banana as ratio of paired samples. Branched-chain amino acids with related volatiles present in headspace highlighted in bold. Dash indicates no significant difference between treatments, ellipsis indicates amino acids that were not quantified.

### Materials and Methods

### Plant Material

‘Gala’, ‘Empire’, ‘Jonagold’, and ‘Red Delicious’ apple fruit (Malus x domestica Borkh.) were harvested from local orchards at commercial maturity and transported to the laboratory during the 2022 and 2023 seasons. As determined by previously described methods, the fruit were at the developmental onset of ripening with no subjectively discernible aroma. ‘Gala’ and ‘Empire’ fruits began treatment immediately after arrival in the laboratory. ‘Jonagold’ fruit were held in air at 0° C. for two days before transfer to controlled atmosphere (CA) storage (1.5 O₂, 3% CO₂, 0° C.) and then kept in CA for twelve days to suppress ethylene action before the initiation of inhibitor treatment. ‘Red Delicious’ fruit were treated with 50 nL·⁻¹ 1-methylcyclopropene (MCP) for 24 h at 0° C. The MCP was evolved from a commercial MCP product (EASYFRESH®, Fine Americas) in sealed chambers two days after harvest as previously described. The fruit were then stored in air at 0° C. for five months and were warmed to 22° C. for 24 h before sulfonylurea treatment. This low-dosage MCP treatment had very mild effects on physiology. After removal from storage and warming, the respiration rate of MCP-treated fruit was 88.7% that of untreated fruit, and the firmness was 57.2 N (untreated fruit were 44 N). Based on the internal ethylene concentration (˜100 μL·L⁻¹) and the total ester production (elevated and trending upwards), the fruit were considered to be of an advanced stage of ripeness, but not senescent. Overall, fruit storage conditions were used as convenient means for manipulating the ripening stage of experimental material, not as experimental variables.

Banana fruit (Musa spp. AAA group, Cavendish subgroup, cv. Valery) that had not been treated with ethylene were obtained from a local supermarket produce distribution and ripening center (Meijer/Chiquita) on the day of their arrival. ‘Valery’ fruit were held at 13.5° C. until treatment. It was noted that fresher fruits provided more consistent results compared to older ones, so fruit were typically used within the first 10 days after procurement.

‘Dr. Banks Pink’ flowering quince fruit (Chaenomeles xsuperba) were collected from accession CC7985*05 on the Michigan State University campus grounds. Fruits were subjectively determined to be producing aroma at the time of harvest.

### Treatment and Sample Preparation

Whole apple fruit, freshly harvested and at an early stage of ripening (‘ripening’), were held at room temperature (22° C.) and rubbed daily with 3 mL of a freshly made 1mM solution of the inhibitor rimsulfuron (N-((4,6-dimethoxypyrimidin-2-yl)aminocarbonyl)-3-(ethylsulfonyl)-2-pyridinesulfonamide, made from DuPont MATRIX® SG, 25% w/w active ingredient; 0.1% Tween 20) or water solution containing 0.1% Tween 20 before preparation with further treatments. Flowering quince fruit were smaller than the apple fruit and had 2 mL of the control and treatment solutions applied daily at 22° C. ‘Gala’, ‘Empire’, and ‘Jonagold’ apple fruit were treated for four, nine, and seven days before further preparation, respectively. Flowering quince fruit were treated for six days before analysis. Headspace volatile emissions were monitored for three or four representative fruits during the incubation/treatment period to determine appropriate times for further treatments. During method testing, 1 mM solutions of the imidazolinone imazamox was also assessed with apple fruit (2-[4,5-dihydro-4-methyl-4-(1-methylethyl)-5-oxo-1H-imidazol-2-yl]-5-(methoxymethyl)-3-pyridinecarboxylic acid, made from RAPTOR®, 12.1% w/w active ingredient; 0.1% Tween 20).

α-Ketoacids (2-oxo acids) were fed to ‘Empire’ and ‘Jonagold’ fruit by preparing vials of excised peel tissue discs in 22-mL glass vials using 20 μL of treatment solution on the prepared paper-peel disc units. Treatment solution contained 20 mM methanol, 0.1% Tween 20, 20 mM of α-keto-β-methylvalerate (3-methyl-2-oxopentanoate), α-ketoisovalerate (3-methyl-2-oxobutanoate), or α-ketoisocaproate (4-methyl-2-oxopentanoate), and when appropriate, 1 mM rimsulfuron.

Acetate feedings were likewise performed with excised peel tissues in 22-mL glass vials and 20 μL of treatment solution. ‘Gala’ fruit were fed with 10 mM methanol, 10 mM acetate (unlabeled or 1,2-¹³C₂) pH 7 balanced with KOH, 0.05% Tween 20, and 0.5 mM rimsulfuron if appropriate. These concentrations were doubled for ‘Empire’ and ‘Jonagold’ fruit.

‘Red Delicious’ apple fruit held in refrigerated air for 5 months (see above) plus 1 day at 22° C. and at an advanced ripeness stage (‘ripe’) were treated with rimsulfuron (1 mM) with 0.2% Tween 20 on day 0 of the study and for the next three consecutive days as above described. The fruit were evaluated daily for volatile emissions (see below) for eight days. On days 0, 2, 4, and 7, representative treated and untreated fruit were selected for tissue collection for metabolite analysis (see below). On day 7, samples of fruit peel were fed, as described above, with water or 20 mM isoleucine or α-keto-β-methylvalerate.

Banana fruit at an early stage of ripening were infiltrated with AHAS inhibitors by two means. The first method was used for the effects of sulfonylureas on volatile and amino acid content, whereas the second was used to investigate the recovery of sulfonylurea-treated fruits after precursor application.

In the first method, mature green ‘Valery’ fruit were cut into ˜1 cm² sections, 2-mm thick, from transverse sections of fruit not treated with ethylene. Care was taken such that one edge of the square was from the edge of the pulp, thus representing an undisturbed or ‘live edge’ of cells that should be able to maintain unhindered gas exchange. Pulp sections were prepared in vials as above described for apples. Treatment solution: 0.5 mM halosulfuron-methyl (methyl 3-chloro-5-(4,6-dimethoxypyrimidin-2-ylcarbamoylsulfamoyl)-1-methylpyrazole-4-carboxylate, made from SANDEA®, Gowan Co. 75% w/w active ingredient; 0.1% Tween 20). Ripening was induced by injection of 1 μL ethylene into the vial's 20-mL headspace. The following day the vials were vented for 15 min before having the Mininert valve (Valco Instruments Co. Inc.) replaced on the vial but with a needle inserted to allow for gas diffusion. Daily for the following two days, 20 μL of freshly made inhibitor or water solution was added onto the pulp. The needles were again kept in the valves to maintain gas diffusion. The next day, and thus four days since initially preparing the vials, the needles were removed, and the vials were sealed and incubated for at least 1 hour at room temperature (22° C.) before headspace sampling.

While the results of inhibition using this methodology were consistent in ripening fruits, maintaining the small pulp sections at an appropriate humidity to allow for ripening while also preventing desiccation and microbial outbreak proved to be exceedingly difficult. Thus, a second methodology was employed. In this case whole mature green banana fruit were gassed with 100 μL·L⁻¹ ethylene for 24 h at 22° C. to trigger ripening. The following day, fruit were sanitized with a mild 5% bleach solution, rinsed with water, wetted with a 95% ethanol solution, and dried under a laminar flow sterile hood. Transverse 1-cm-thick banana disks including peel were excised and infiltrated with AHAS inhibitors under aseptic conditions. Rimsulfuron was applied at 0.025 and 0.0125 mM, imazamox was applied at 0.125 and 0.5 mM, and halosulfuron-methyl was applied at 0.0125 and 0.05 mM. To infiltrate, the discs were mounted in 60-mL glass Buchner funnels with either coarse or medium frit filters. The surface of the frit was covered with a filter paper disk (Whatman, No. 2) and a seal was made between the tissue disk and the inner wall of the funnel using a warm 1% agar solution, which, as it cooled, was built up to form an elevated surface around the disk. The upper surface of the peel tissue was sealed with a layer of agar to restrict flow of the inhibitor to the pulp tissues only. Care was taken to prevent the agar from seeping under the disk and blocking the filter paper pores. The inhibitor solution (2 mL) was applied to the upper surface of the disk and vacuum (<5 mm Hg) was applied for 3 to 5 minutes until all the applied solution was pulled through the disk and the visible surface of the disk appeared dry. The disks were removed from the funnels and cleaned of residual agar before transfer to filter paper disks in sterile glass canning jars (480 mL). The jars were sealed with a metal lid in which a 7-mm dia. rubber septum was mounted. Disks were treated with 100 μL·L⁻¹ ethylene and jars vented daily to minimize CO₂ buildup and O₂ depletion. Volatile analysis was performed 4 d after the initiation of ripening. This method, when fresh fruit were used, led to more reliable ripening with less maintenance than the first method and yielded the same volatile content shifts.

To study complementation, small sections of pulp were prepared as above described and fed 80 μL of 4 mM α-ketoisovalerate, 4 mM α-ketoisocaproate, 20 mM valine, or 20 mM leucine. The different α-ketoacid and amino acid concentrations were used to obtain comparable recoveries of the downstream esters.

### Volatile Analysis

Headspace volatiles from small tissue samples incubated in 22 mL vials were adsorbed for 30 s using a solid-phase micro extraction (SPME) fiber (65 μm PDMS-DVB; Supelco Analytical). The SPME fiber was then directly desorbed for 1 min in the injection port of a gas chromatograph (GC; HP-6890, Hewlett-Packard) coupled to a time-of-flight mass spectrometer (MS; Pegasus II, LECO). Whole fruits and banana slices were incubated for 20 min at room temperature (22° C.) in 1-L sealed Teflon jars before a 15-s, or 3-min adsorption and 1- or 2-min desorption. Adsorption times were adjusted to ensure instrument responses were in the linear range. All desorbed volatiles were cryofocused at the beginning of the column by immersing said region of the column in liquid nitrogen. After the desorption period, the run was initiated and the liquid nitrogen removed.

The conditions of the system were as follows. Injection port: 200° C., splitless, ultra-purified helium (99.999%) carrier gas, front inlet flow 1.5 mL·min⁻¹ constant, 10 mL·min⁻¹ purge flow, 11.5 mL·min⁻¹ total flow. Oven: initial temperature 40° C. for 0 min, ramped by 43° C.·min⁻¹ to 185° C. for 0 min. Column: HP-5 MS, 30 m×0.25 mm i.d., 0.25 μm film thickness (Agilent). Transfer line temperature 225° C. MS: Electron ionization (−70 eV), ion source temperature 200° C., solvent delay 50 sec, m/z range 29 to 400, detector voltage 1500 V, data collection rate 20 Hz.

When α-ketoisocaproate was supplied to apple fruit and separation of 2-methylbutyl acetate and 3-methylbutyl acetate was of interest, the following oven parameters were used: initial 40° C. for 0 min, 10° C.·min⁻¹ until 100° C., 20° C.·min⁻¹ until 130° C., 60° C.·min⁻¹ until 185° C.

Compounds were identified by comparison of the retention time and mass spectrum against authenticated reference standards and spectra (National Institute of Standards and Technology Mass Spectral Search Program Version 2.0, 2001). Volatiles were quantified by calibration with a standard of 59 authenticated, high-purity compounds (Sigma-Aldrich Co. and Fluka Chemical) including the target compounds. The standard was made by placing 0.5 μL of an equal-part mixture of the neat compounds onto a disc of filter paper before quickly placing the filter paper into a 4-L sealed flask fitted with a Mininert valve (for SPME fiber access, and allowed to vaporize for at least 6 hours. SPME adsorption and desorption times of the standard matched that of the samples quantified (e.g., 30-s adsorption, 1 min desorption when quantifying samples in 22-mL vials).

After volatile analysis, apple peel disks, collected peel of flowering quince, and ‘Valery’ pulp section samples were held at −80° C. for further amino acid analysis.

### Validation of SPME Methodology

A series of standard mixtures, composed of 68 authenticated, high-purity alcohols, esters, and estragole were prepared. One mixture contained all 68 compounds in equal-volume parts, the other mixtures were prepared such that 66 of the compounds were maintained at the same concentration whereas two esters, 1-methylbutyl acetate and 1-methylbutyl butanoate, were selectively diluted to 50, 20, 10, 5, 2, and 1% of their original concentrations. Headspaces of these mixtures were prepared in 4-L flasks as described above. Adsorption times were 30 s or 3 min, cryofocused desorption periods were kept at 2 min. GCMS parameters, compound identification, and compound quantification were as described above.

The logarithmically scaled relationship between the diluted ester concentrations and instrument response were linear regardless of adsorption period (R²>0.996). The slopes (average of 1.081) are very close to their theoretical value (1.000) and are within the expected margin of error when handling μL quantities of liquids. This error is also much less than the biological variation observed herein. Thus, in this case, diluted compounds among a relatively concentrated background can be reliably quantified without the influence of matrix effects.

Furthermore, the effect of adsorption time was assessed using the full-strength 68 compound mixture. Longer adsorption periods, in this case greater than 150 s, led to an apparent matrix effect as the response of lower molecular mass compounds were displaced by heavier ones. However, if the adsorption period was strictly consistent, there was no impact on response linearity, indicating no meaningful impact for quantification at either 30 s or 180 s.

### Amino Acid Analysis via UPLC-MS/MS

Frozen samples were ground to a powder in liquid nitrogen-chilled mortar and pestles. About 500 mg of tissue was vortexed for 10 sec in 2 mL of room temperature (22° C.) extraction solution (1:1:1 water:acetonitrile:ethanol, v/v/v) spiked with 2 nmoles of U-¹³C,¹⁵N labeled amino acids (MilliporeSigma) as internal standards and heated for 15 min in a 65° C. water bath. Extracts were briefly chilled on ice before centrifugation at 4400×g for 15 min at 4° C. The supernatant was filtered by centrifugation (0.2 μm nylon centrifugal filter; Costar, Corning) at 21000×g for 5 min at room temperature. 10 μL of the filtrate was transferred to an autosampler vial and diluted 100-fold with 990 μL of 10.1 mM perfluorohexanoic acid (PFHA) spiked with 2 μmoles of internal standard. Thus the final concentration of internal standard was ˜2 μM.

An amino acid standard series was prepared from a premade mixture (MilliporeSigma, AAS18) that contained equal molar amounts of cystine and all 20 proteinogenic amino acids save for tryptophan, asparagine, glutamine, and cysteine. An equal molar mixture of tryptophan, asparagine, glutamine, and cysteine was subsequently prepared. To avoid dilution errors or artefacts from differing buffers, these amino acid stocks were aliquoted and desiccated such that a five-part standard series ranging from 250 μM to 25 nM would be produced upon resuscitation with 10 μL of spiked extraction buffer and 990 μL spiked PFHA solution.

Samples and amino acids were held overnight at −20° C. before analysis. Amino acids were analyzed with a Xevo TQ-S Micro UPLC (H-Class)-MS/MS (Waters) at the Michigan State University Mass Spectrometry and Metabolomics Core. Conditions were as follows. HPLC column: Acquirt UPLC HSS T3, 2.1×100 mm, 1.7 μm particle size (Waters), with a 0.2 μm pre-column filter (Waters). Mobile phase: A) 10 mM PFHA in water, B) acetonitrile. LC gradient: linear gradient, slope setting=6, flow rate=0.3 mL·min⁻¹, step 1) 0 min, 100% A, 0% B, 2) 1 min, 100% A, 0% B, 3) 8 min, 35% A, 65% B, 4) 8.01 min, 10% A, 90% B, 5) 9 min, 10% A, 90% B, 6) 9.01 min, 100% A, 0% B, 7) 13 min, 100% A, 0% B. Column temp: 40° C. Autosampler temp: 10° C. Injection volume: 10 μL. Tune parameters: electrospray ionization, standard ESI probe, capillary voltage=+1.0 kV, source temp=120° C., desolvation temp=350° C., desolvation gas=800 L·hr⁻¹, cone gas=40 L·hr⁻¹. MS collection was split into three phases and were adjusted after checking the retention time of several samples; however proline was missed for apple and flowering quince samples. Quantification was performed by comparison of the ratios of peak areas of metabolites to labeled internal standards.

### Precursor Analysis Via Derivatization and GCMS

To simultaneously quantify branched-chain α-ketoacids and amino acids, 100 mg of ground frozen tissue was extracted in 2 mL of 1:1 acetonitrile: water containing 13 μM U-¹³C, ¹⁵N labeled amino acids (MilliporeSigma) as internal standard for 15 min in a 65° C. water bath. Extracts were briefly chilled on ice before being centrifuged at 4400×g for 10min at 4° C. Supernatant was transferred to a microcentrifuge tube and further centrifuged at 21000×g for 10 min prior to syringe filtration (0.45 μm, 13 mm dia. nylon filters with polypropylene syringes; Whatman, Cytiva). Precisely 1.5 mL of filtrate was alkalized to pH>7.5 with 50 μL of 1M NaOH, verified with 50 μL of 1% w/v 4-nitrophenol. Samples were desiccated overnight via rotovac (DNA 100 Speed Vac, Savant.) at 22° C. Sample were first derivatized via methoxyamination by addition of 100 μL of 40 mg·mL⁻¹ methoxyamine hydrochloride in anhydrous pyridine and incubation for at least 12 hours at 60° C. They were next derivatized via tert-butyldimethylsilyation by addition of 100 μL of N-methyl-N-tert-butyldimethylsilyltrifluoroacetamide containing 1% tert-butyldimethylsilyl chloride and incubation for at least 12 hours at 60° C. Derivatized samples were centrifuged 21000×g for 5 min before transferring supernatant into autosampler vials. If analysis was delayed, derivatized samples were held at −20° C.

One microliter of derivatized sample was analyzed with a GC (Agilent 6890) coupled to a time-of-flight MS (Pegasus II, LECO). The conditions of the system were as follows: Injection port: 250° C., 5:1 split, helium carrier gas, 7.5 mL·min⁻¹ split flow, 9 mL·min⁻¹ total flow. Oven: initial temperature at 80° C. for 0 min, ramped by 30° C.·min⁻¹ to 130° C. for 0 min, then ramped at 15° C./min to 250° C. for 0 min, then ramped at 40° C.·min⁻¹ to 300° C. for 4 min. Column: VF-5 ms, 30 m×0.25 mm i.d., 0.25 μm film thickness (Agilent, Santa Clara, CA). Transfer line temperature 300° C. MS: Electron ionization (−70 eV), ion source temperature 230° C., scanning 29-600 u, 20 spectra·s⁻¹, 1800 acquisition voltage. Relatively high citramalate levels necessitated rerunning samples at a 20:1 split to avoid over saturation of the detector.

Compounds were identified by retention time and spectra of derivatized authenticated standards. Quantification was performed by comparison of the ratios of peak areas of metabolites to labeled internal standards. Among compounds that did not have a labeled internal analog present, peak area ratios were compared against a labeled amino acid: α-ketoacids to valine, and citramalate and α-isopropylmalate to isoleucine. Calibration standards consisted of equimolar mixtures of the analyzed compounds that mimicked 15-0.15 nmoles of analyte in the final derivatized sample.

Great care went into the accurate quantification of α-keto-β-methylvalerate. Methoxyamination results in an imine whose cis-trans isomers may chromatographically separate. Furthermore, the chiral carbon of α-keto-β-methylvalerate racemizes in alkaline conditions. Under our analytical conditions, derivatized α-keto-β-methylvalerate manifests as a triplet. To counter this dilution of signal, detector voltage was increased from routine conditions (1500 to 1800 V).

While results from the derivatization of banana tissue are not reported herein, it is worthwhile mentioning that tissues with higher sugar content, such as banana fruit pulp, necessitate greater amounts of derivatizing reagent. It was found that 400 μL of each reagent per 100 mg of banana tissue is a good compromise.

### Statistical Analysis

Statistical analysis was performed using SciPy (v1.6.2), RStudio (v2023.03.0+386), or Microsoft Excel (v16.89). Against a specified value: one-tailed t-test Against two treatments: paired t-test for banana, two-sample t-test for apple and flowering quince. Against more than two treatments: Tukey's test following significant ANOVA. Analyses of branched-chain amino acids were one-tailed, all other metabolites were two-tailed. The exogenous feedings of metabolites led to unequal variance, in these cases data was transformed via log(x+1) before statistical analysis. In all analyses α=0.05. The percent of metabolite content of treated tissues against control was calculated for each sulfonylurea-treated sample against average of controls for apples and flowering quince (unpaired samples), for bananas it was calculated against paired control sample.

### Discussion

The categorical suppression of all isoleucine-, valine-, and leucine-related volatiles by upwards of 90% in the fruit tissues treated with an AHAS inhibitor robustly supports the hypothesis that these ripening fruit tissues rely heavily upon newly synthesized precursors to produce these important sensory compounds. Seemingly only a very modest contribution is made from preexisting sources in the tested tissues; and there may be situations/fruits where they contribute more substantially. However, given that we likely did not observe complete inhibition of AHAS (e.g., inhibition of plant AHAS by sulfonylureas plateaus at ˜85% and efficacy/penetration with the fruit tissues used is unclear), it is conceivable that virtually all anteiso- and iso-branched-chain ester synthesis is reliant upon de novo synthesized precursors in fruits.

As none of the fruits produce branched-chain esters that correspond to all three branched-chain amino acids, the parallel increases of the specific amino acids and their related volatiles in apple and banana fruit are seemingly due to specific portions of the branched-chain biosynthetic pathways undergoing programmed enhancements during ripening.

One of these enhancements seems to be the genetic expression of AHAS itself. Transcriptomic datasets indicate the expression of its catalytic subunit to be constitutively expressed throughout apple and banana fruit development with expression increasing 1.4-fold and 2.7-fold in ripening apple and banana fruits, respectively. However, as AHAS leads to the synthesis of all three branched-chain amino acids, other specific enhancements of the anteiso- or iso-branched pathway segments are necessary. In apple, this enhancement manifests as a 104.7-fold increase of citramalate synthase expression in ripening fruit peel during ripening, leading to the increased and non-feedback regulated production of the AHAS substrate, α-ketobutyrate, for the synthesis of anteiso-branched-chain metabolites (FIG. 1).

As shown herein, the formation of branched-chain ester moieties in apple fruit relies on precursors derived upstream of AHAS. This finding is entirely consistent with the characterization of apple cultivars lacking an enzymatically active allele of citramalate synthase; these cultivars do not accumulate substantial quantities of isoleucine or anteiso-branched-chain esters during ripening. Taken together, citramalate synthase appears to be critical to supplying the precursors of anteiso-branched-chain ester biosynthesis in apple fruit.

As inhibition of AHAS in apple fruit effectively eliminates the influx of carbon from α-ketobutyrate to branched-chain metabolism, flux should then be shunted towards further straight-chain elongation via citramalate synthase (FIG. 1). The increased headspace concentrations and stable-isotope enrichment of pentyl acetate and methyl pentanoate, respectively, after rimsulfuron application is striking, however it is unclear why there were not concomitant changes to other straight-chain esters as well. Further experimentation that targets the citramalate synthase pathway as well as ‘canonical’ straight-chain ester biosynthesis pathways involving fatty acids will aid in better understanding the contributions of these sources to straight-chain ester biosynthesis in apple fruit.

The results also demonstrate that apple and banana fruit, despite not normally producing appreciable amounts of all three classes of anteiso- and iso-branched-chain esters, have no general hindrance to synthesizing said esters when a supply of the corresponding α-ketoacids or amino acid is present. Thus, how precursor biosynthesis is engaged, such as anteiso-branched chain metabolism in apple or iso-branched chain metabolism in banana, and what precursors accumulate in ripening fruits, plays an important role in determining a fruit's resulting aroma profile.

In addition to the above inferences, the use of these inhibitors on banana fruit allows for the suggestion of the presence of a previously unknown means of butyl and butanoate ester biosynthesis. This appears to be unique to banana fruit since similar results were not observed in apple or flowering quince. Apart from some specialized instances of straight-chain 1-C elongation from α-ketobutyrate that have been documented in apple (via citramalate synthase) and in Solanaceae, it has largely been assumed that butyl and butanoate esters are derived from β-oxidation of fatty acids: a catabolic process. As treatment of tissues with AHAS inhibitors does not lead to inhibition of fatty acid synthesis, the results suggest that the source of butyl and butanoate esters in banana fruit may originally be from branched-chain amino acid metabolism.

Some of the first scientific work that attempted to establish a relationship between leucine and 3-methylbutyl esters found that bananas fed U-¹⁴C-leucine produced a significantly enriched volatile fraction containing butyl butanoate and 1-methylbutyl butanoate. In light of these results, it is proposed that α-ketoisocaproate may be the metabolite that banana fruit use to bridge branched-chain amino acid and butanoate metabolisms, however additional work is needed to elucidate how this is facilitated.

The sulfonylurea-induced inhibition of ethyl acetate synthesis in banana fruit is surprising. However, another past study that likewise fed U-¹⁴C-leucine to ripening banana fruit found isotopic enrichment of the acetate moiety of 3-methylbutyl acetate¹, leading to the suggestion that even the precursors of ethyl acetate may be derived from branched-chain amino acid metabolism in banana fruit.

The lack of suppression of 2-pentanol, 2-pentanone, and 1-methylbutyl esters by the inhibitors strongly suggests that these sec-branched-chain compounds of banana fruit are derived from a source that is not within the sphere of AHAS's influence. It is striking that banana fruit should produce multiple forms of branched-chain esters (iso- and sec-branched), that are of seemingly wholly independent origins.

In flowering quince, our indicate that these fruit, like apple and banana fruit, rely largely upon de novo precursor synthesis to produce branched-chain volatiles. While our results cannot indicate whether the citramalate synthase pathway is present in flowering quince, the sole increase of propyl acetate after sulfonylurea application is, perhaps, telling. As propyl acetate is a potential product of α-ketobutyrate (FIG. 1) and longer straight-chain products are not enhanced as they are in apple fruit, 1-C elongation of straight-chain α-ketoacids is likely not occurring in flowering quince.

Ultimately, as branched-chain α-ketoacids are direct products of de novo synthesis, and if branched-chain esters are directly derived from branched-chain α-ketoacids, then interconversion of the amino acids and α-ketoacids may be unnecessary for ester biosynthesis. Thus, the substantial accumulation of branched-chain amino acids in these ripening fruits may be a byproduct of the enhancement of the biosynthetic branched-chain pathways, routed through AHAS, leading to branched-chain volatiles. On the other hand, in the later stages of ripening, it may also be that the accumulated branched-chain amino acids act as a storage reservoir that provides a buffering pool of available precursor. Regardless, as de novo synthesis of at least the branched-chain α-ketoacids is necessary for branched-chain volatile synthesis, these volatiles are referred to as being ‘related to’ branched-chain amino acids, rather than being ‘derived from’ them.

Collectively, the use of AHAS inhibitors allows for rejection of the hypothesis that branched-chain esters are derived from preexisting branched-chain amino acids and α-ketoacids, and instead support the hypothesis that these esters are the product of de novo precursor biosynthesis. While inhibitors of general physiological processes, such as ethylene perception, protein synthesis, or respiration (via application of 1-methylcyclopropene, cycloheximide, potassium cyanide, arsenate, or 2,4-dinitrophenol), have been applied to ripening apple and/or banana fruit to study aroma production, no other published work utilizing herbicidal enzymatic inhibitors to discern volatile biosynthetic pathways was found, despite their use in the investigation of many important aspects of plant metabolism and physiology. Future use of these and other enzymatic inhibitors on fruits should result in further advances on precursor production and aroma biochemistry in general.

Lastly, it is worthwhile pursuing the logical extension to these results. As demonstrated, ripening apple and banana fruits produce anteiso- and iso-branched-chain esters from newly synthesized precursors. However, the pathways that produce said precursors are normally regulated by strict allosteric feedback mechanisms. The ability of these fruits to increase flux through these pathways during ripening seems paradoxical. While citramalate synthase explains how apple fruit circumvent such regulation, it is still unknown what regulatory changes occur in ripening banana fruits.

### References

Ahan, T. W.; Kim, D. W.; Choi, J. D. Inhibition of acetohydroxyacid synthase by sulfonylureas and imidazolinones. Korean Biochem. J., 1992, 25, 636-641.
Alsmairat, N.; Engelgau, P.; Beaudry, R. Changes in free amino acid content in the flesh and peel of ‘Cavendish’ banana fruit as related to branched-chain ester production, ripening and senescence. J. Am. Soc. Hortic. Sci. 2018, 5, 370-380.
Asif, M. H.; Lakhwani, D.; Pathak, S.; Gupta, P.; Bag, S. K.; Nath, P.; Trivedi, P. K. Transcriptome analysis of ripe and unripe fruit tissue of banana identifies major metabolic networks involved in fruit ripening process. BMC Plant Biol. 2014, 14, 1471-2229.
Bizzio, L.; Tieman, D.; Munoz, P. Branched-chain volatiles in fruit: a molecular perspective. Front. Plant Sci. 2022, 12, 814138.
Breccia, G.; Vega, T.; Felitti, S. A.; Picardi, L.; Nestares, G. Differential Expression of Acetohydroxyacid Synthase Genes in Sunflower Plantlets and Its Response to Imazapyr Herbicide. Plant Sci. 2013, 208, 28-33.
Croteau, R. Biogenesis of flavor components: volatile carbonyl compounds and monoterpenoids. In Postharvest Biology and Biotechnology; Hultin, H.O., Milner, M., Eds.; Food & Nutrition Press, Inc.: Westport, CT, 1978.
da Silva, A.; Engelgau, P.; Sugimoto, N.; Beaudry, R. Factors affecting 1-MCP release from an α-cyclodextrin encapsulant dissolved in water. Acta Horitc. 2023, 32, 97-94.
Dayan, F. E.; Duke, S. O.; Grossmann, K. Herbicides as probes in plant biology. Weed Sci. 2010, 58, 340-350.
Duan, N.; Bai, Y.; Sun, H.; Wang, N.; Ma, Y.; Li, M.; Wang, X.; Jiao, C.; Legall, N.; Mao, L. et al. Genome re-sequencing reveals the history of apple and supports a two-stage model for fruit enlargement. Nat. Commun. 2017, 8, 249.
Duhoux, A.; Carrère, S.; Gouzy, J.; Bonin, L.; Délye, C. RNA-Seq Analysis of Rye-Grass Transcriptomic Response to an Herbicide Inhibiting Acetolactate-Synthase Identifies Transcripts Linked to Non-Target-Site-Based Resistance. Plant Mol. Biol. 2015, 87, 473-487.
Espino-Díaz, M.; Sepúlveda, D. R.; González-Aguilar, G.; Olivas, G. I. Biochemistry of Apple Aroma: A Review. Food Technol. Biotechnol 2016, 4, 375-397.
Ferenczi, A.; Song, J.; Tian, M.; Vlachonasios, K.; Dilley, D.; Beaudry, R. Volatile ester suppression and recovery following 1-methylcyclopropene application to apple fruit. J. Amer. Soc. Hort. Sci. 2006, 131, 691-701.
Ferenczi, A.; Sugimoto, N.; Beaudry, R. Emission patterns of esters and their precursors throughout ripening and senescence in ‘Redchief Delicious’ apple fruit and implications regarding biosynthesis and aroma perception. J. Am. Soc. Hortic. Sci. 2021, 146, 297-328.
Golding, J. B.; Shearer, D.; McGlasson, W. B.; Wyllie, S. G. Relationships between respiration, ethylene, and aroma production in ripening banana. J. Agric. Food Chem. 1999, 14, 1646-1651.
Golding, J. B.; Shearer, D.; Wyllie, S. G.; McGlasson, W. B. Application of 1-MCP and propylene to identify ethylene-dependent ripening processes in mature banana fruit. Postharvest Biol. Technol. 1998, 14, 87-98.
Gonda, I.; Bar, E.; Portnoy, V.; Lev, S.; Burger, J.; Schaffer, A. A.; Yadmor, Y.; Gepstein, S.; Giovannonni, J. J.; Katzir, N.; Lewinsohn, E. Branched-chain and aromatic amino acid catabolisminto aroma volatiles in Cucumis melo L. fruit. J. Exp. Bot. 2010, 4, 1111-1123.
Gonda, I.; Lev, S.; Bar, E.; Sikron, N.; Portnoy, V.; Davidovich-Rikanati, R.; Burger, J.; Schaffer, A. A.; Tadmor, Y.; Giovannonni, J. J.; Huang, M.; Fei, Z.; Katzir, N.; Fair, A.; Lewinsohn, E. Catabolismof L-methionine in the formation of sulfur and other volatiles in melon (Cucumis melo L.) fruit. Plant J. 2013, 74, 458-472.
Gortner, W. A.; Dull, G. G.; Krauss, B. H. Fruit development, maturation, ripening, and senescence: a biochemical basis for horticultural terminology. HortScience 1967, 4, 141-144.
Guadagni, D.; Bomben, J.; Hudson, J. Factors influencing the development of aroma in apple peels. J. Agric. Food Chem. 1971, 3, 110-115.
Heath, H.; Reineccius, G. Flavor Chemistry and Technology; AVI Publishing Company: Inc. Westport, CT, 1986.
Horzum, Ö.; Sugimoto, N.; Engelgau, P.; Beaudry R., Dose response of air-stored ‘Red Delicious’ fruit to 1-MCP given as single and continuous doses. Fruit Quarterly, 2024, 32, 11-14.
Kays, S.; Paull, R. Postharvest Biology; Exon Press: Athens, GA, 2004.
Knee, M.; Hatfield, S. G. S.; Ratnayake, M. Limitations in the use of cyclohexamide in studies of apple ripening. J. Exp. Bot. 1976, 27, 105-120.
Kochevenko, A.; Araújo, W.; Maloney, G.; Tieman, D.; Do, P.; Taylor, M.; Klee, H. J.; Fernie, A. R. Catabolismof branched chain amino acids supports respiration but not volatile synthesis in tomato fruits. Mol. Plant 2012, 2, 366-375.
Kroumova, A. B.; Wagner, G. J. Different elongation pathways in the biosynthesis of acyl groups of trichome exudate sugar esters from various solanaceous plants. Planta 2003, 216, 1013-1021.
Maloney, G.; Kochevenko, A.; Tieman, D.; Tohge, T.; Krieger, U.; Zamir, D.; Taylor, M. G.; Fernie, A. R.; Klee, H. J. Characterization of the branched-chain amino acid aminotransferase enzyme family in tomato. Plant Physiol. 2010, 153, 925-936.
Manabe, Y.; Tinker, N.; Colville, A.; Miki, B. CSR1, the Sole Target of Imidazolinone Herbicide in Arabidopsis thaliana. Plant Cell Physiol. 2007, 48 (9), 1340-1358.
McCourt, J. A.; Pang, S. S.; King-Scott, J.; Guddat, L. W.; Duggleby, R. G. Herbicide-binding sites revealed in the structure of plant acetohydroxyacid synthase. Proc. Natl. Acad. Sci. U.S.A. 2006, 3, 569-573.
Myers, M. J.; Issenberg, P.; Wick, E. L. L-Leucine as a precursor of isoamyl alcohol and isoamyl acetate, volatile aroma constituents of banana fruit discs. Phytochemistry 1970, 8, 1693-1700.
Myers, M. J.; Issenberg, P.; Wick, E. L. Vapor analysis of the production by banana fruit of certain volatile constituents. J. Food Sci. 1969, 34, 504-509.
Palmer, J.; McGlasson, W. Respiration and ripening of banana fruit slices. Aust. J. Biol. Sci. 1969, 22, 87-99.
Pott, D.; Osorio, S.; Vallarino, J. From central to specialized metabolism: an overview of some secondary compounds derived from primary metabolism for their role in conferring nutritional and organoleptic characteristics to fruit. Front. Plant Sci. 2019, 835.
Ray, T. B. Site of action of chlorsulfuron. Plant Physiol. 1984, 3, 827-831.
Rodríguez, A.; Alquézar, B.; Peña, L. Fruit aromas in mature fleshy fruits as signals of readiness for predation and seed dispersal. New Phytol. 2013, 1, 36-48.
Rowan, D. D.; Lane, H. P.; Allen, J. M.; Fielder, S.; Hunt, M. B. Biosynthesis of 2-methylbutyl, 2-methyl-2-butentyl, and 2-methylbutanoate esters in Red Delicious and Granny Smith apples using deuterium-labeled substrates. J. Agric. Food Chem. 1996, 44, 3276-3285.
Shaner, D. L.; Reider, M. L. Physiological responses of corn (Zea mays) to AC 243,997 in combination with valine, leucine, and isoleucine. Pestic. Biochem. Physiol. 1986, 2, 248-257.
Shaner, D. L.; Singh, B. K. Acetohydroxyacid synthase inhibitors. In Herbicide Activity: Toxicology, Biochemistry and Molecular Biology; Roe, R. M.; Burton, J. D.; Kuhr, R. J., Eds.; IOS Press: Amsterdam, Netherlands, 1997.
Song, J.; Gardner, B.; Holland, J.; Beaudry, R. Rapid analysis of volatile flavor compounds in horticultural produce using SPME and GC/time-of-flight mass spectrometry. J. Agric. Food Chem. 1997, 45, 1801-1807.
Sugimoto, N.; Engelgau, P.; Jones, A. D.; Song, J.; Beaudry, R. Citramalate synthase yields a biosynthetic pathway for isoleucine and straight- and branched-chain ester formation in ripening apple fruit. Proc. Natl. Acad. Sci. U.S.A. 2021, 3, e2009988118.
Sugimoto, N.; Jones, A. D.; Beaudry, R. Changes in free amino acid content in ‘Jonagold’ apple fruit as related to branched-chain ester production, ripening, and senescence. J. Am. Soc. Hortic. Sci. 2011, 6, 429-440.
Tewari, Y.; Goldberg, R.; Rozzell, J. Thermodynamics of reactions catalysed by branched-chain-amino-acid transferase. J. Chem. Thermodyn. 2000, 10, 1381-1398.
Tressl. R.; Drawert. F. Biogenesis of banana volatiles. J. Agric. Food Chem. 1973, 4, 560-565.
Wyllic. S. G.; Fellman. J. K. Formation of volatile branched chain esters in bananas (Musa sapientum L.). J. Agric. Food Chem. 2000, 8, 3493-3496.

What is claimed is:

1. A method of altering the flavor of a fruit or vegetable, the method comprising: contacting the fruit or vegetable with a composition comprising an acetohydroxyacid synthase (AHAS) inhibitor.

2. The method of claim 1, wherein the fruit or vegetable is a harvested fruit or vegetable.

3. The method of claim 1, wherein the fruit or vegetable is an apple, banana, melon, grape, mango, or pear.

4. The method of claim 1, wherein the AHAS inhibitor comprises an imidazolinone, a sulfonylurea, a triazolopyrimidine, a pyrimidinyl benzoate, or a sulfonylamino carbonyl triazolinone.

5. The method of claim 1, wherein one or more branched-chain metabolites are reduced in the fruit or vegetable.

6. A method of reducing one or more methoxypyrazines in grapes or a grape product, the method comprising:
contacting the grapes with a composition comprising an acetohydroxyacid synthase (AHAS) inhibitor.

7. The method of claim 6, wherein the grape product is grape juice or wine.

8. The method of claim 6, wherein the AHAS inhibitor comprises an imidazolinone, a sulfonylurea, a triazolopyrimidine, a pyrimidinyl benzoate, or a sulfonylamino carbonyl triazolinone.

9. A method of producing wine with an altered flavor, the method comprising:
contacting grapes with a composition comprising an acetohydroxyacid synthase (AHAS) inhibitor; and
producing a wine from the grapes.

10. The method of claim 9, wherein the altered flavor comprises reduced green character.

11. The method of claim 9, wherein one or more methoxypyrazines are reduced in the wine.

12. The method of claim 9, wherein the wine is a red wine.

13. The method of claim 9, wherein the AHAS inhibitor comprises an imidazolinone, a sulfonylurea, a triazolopyrimidine, a pyrimidinyl benzoate, or a sulfonylamino carbonyl triazolinone.

14. A treatment composition for fruits or vegetables comprising:
an acetohydroxyacid synthase (AHAS) inhibitor; and
one or more agriculturally acceptable auxiliaries.

15. The composition of claim 14, wherein the AHAS inhibitor comprises an imidazolinone, a sulfonylurea, a triazolopyrimidine, a pyrimidinyl benzoate, or a sulfonylamino carbonyl triazolinone.

16. The composition of claim 14, wherein the one or more agriculturally acceptable auxiliaries comprise an extender, solvent, carrier, emulsifier, dispersant, thickener, or adjuvant.

17. A plant part having the composition of claim 14 applied to the surface.

18. The plant part of claim 17, wherein the plant part is a harvested plant part.

19. The plant part of claim 17, wherein the plant part is a fruit or vegetable.

20. The plant part of claim 19. wherein the fruit or vegetable is an apple, banana. melon, grape, mango, or pear.
